(19) United States
(12) Patent Application Publication
(10) Pub. No.: US 2025/0370393 A1
(43) Pub. Date: Dec. 4, 2025

(54) IMAGE FORMING APPARATUS AND METHOD FOR PRODUCING PRODUCT

(71) Applicant: CANON KABUSHIKI KAISHA, Tokyo (JP)

(72) Inventors: KATSUHITO SHIRATORI, Shizuoka (JP); TAKURO MITA, Kanagawa (JP)

(21) Appl. No.: 19/209,580

(22) Filed: May 15, 2025

(30) Foreign Application Priority Data
May 30, 2024 (JP) 2024-088166

(51) Int. Cl. G03G 15/00; B42C 9/00; G06F 3/12

(52) U.S. Cl. CPC G03G 15/6544; B42C 9/0081; G03G 15/6573; G03G 15/6579; G03G 15/6585; G06F 3/1208; G06F 3/1252; G03G 2215/00835

(57) ABSTRACT

An image forming apparatus includes a transfer member, a fixing unit, a binding unit, and a control unit for producing a product including a double-page spread. The control unit causes transfer of a first image onto the first surface before the first sheet passes through the fixing unit for a first time, fixing the first image on the first sheet, transfer of a second image onto the second surface before the second sheet passes through the fixing unit for a first time, fixing the second image on the second sheet, and binding of the first sheet and the second sheet by the binding unit such that the first surface and the second surface face each other.

### BACKGROUND

### Field of the Technology

The present disclosure relates to an image forming apparatus that forms an image on a sheet.

### Description of the Related Art

Japanese Patent Application Laid-Open No. 2004-209859 discusses a sheet bonding apparatus that bonds sheets together by heating and pressing the sheets, to which toner serving as an adhesive is applied and which are stacked before bonding, as well as an image forming apparatus equipped with such a sheet bonding apparatus. Japanese Patent Application Laid-Open No. 2004-289660 discusses a printing technique in which an original image is divided and printed onto sheets of printing paper, along with information printed on the sheets indicating the order for joining the sheets together and the boundaries of adhesive margin areas.

### SUMMARY

According to the present disclosure, an image forming apparatus and a method for producing a product, which are capable of suppressing a difference in image size between images in a product, can be provided.

An aspect of the disclosure provides an image forming apparatus that includes a transfer member configured to transfer an image onto a sheet, a fixing unit configured to fix the image on the sheet by heating the sheet, a binding unit configured to bind a plurality of sheets, and a control unit configured to perform a job for producing a product formed by a first surface of a first sheet and a second surface of a second sheet. In the job, the control unit is configured to cause (i) transfer of a first image onto the first surface of the first sheet by the transfer member before the first sheet passes through the fixing unit for a first time, (ii) fixing of the first image on the first sheet by the fixing unit, (iii) transfer of a second image onto the second surface of the second sheet by the transfer member before the second sheet passes through the fixing unit for a first time, (iv) fixing of the second image on the second sheet by the fixing unit, and (v) binding of the first sheet and the second sheet by the binding unit such that the first surface and the second surface face each other.

Another aspect of the disclosure provides an image forming apparatus that includes a transfer member configured to transfer an image onto a sheet, a fixing unit configured to fix the image on the sheet by heating the sheet, a binding unit configured to bind a plurality of sheets, and a control unit configured to execute a job for producing a product formed by a first surface of a first sheet and a second surface of a second sheet. In the job, the control unit is configured to cause (i) transfer of a first image onto the first surface of the first sheet by the transfer member after the first sheet has passed through the fixing unit at least once, (ii) fixing of the first image on the first sheet by the fixing unit, (iii) transfer of a second image onto the second surface of the second sheet by the transfer member after the second sheet has passed through the fixing unit at least once, (iv) fixing of the second image on the second sheet by the fixing unit, and (v) binding of the first sheet and the second sheet by the binding unit such that the first surface and the second surface face each other.

Another aspect of the disclosure provides a method for producing a product, the method including (i) transferring a first image onto a first surface of a first sheet before the first sheet passes through a fixing unit for a first time, (ii) fixing the first image on the first sheet by heating the first sheet at the fixing unit, (iii) transferring a second image onto a second surface of a second sheet before the second sheet passes through the fixing unit for a first time, (iv) fixing the second image on the second sheet by heating the second sheet at the fixing unit, and (v) binding the first sheet and the second sheet such that the first surface and the second surface face each other, so that a product formed by the first surface of the first sheet and the second surface of the second sheet is produced.

Another aspect of the disclosure provides a method for producing a product, the method including (i) transferring a first image onto a first surface of a first sheet after the first sheet has passed through the fixing unit at least once, (ii) fixing the first image on the first sheet by heating the first sheet at the fixing unit, (iii) transferring a second image onto a second surface of a second sheet after the second sheet has passed through the fixing unit at least once, (iv) fixing the second image on the second sheet by heating the second sheet at the fixing unit, and (v) binding the first sheet and the second sheet such that the first surface and the second surface face each other, so that a product formed by the first surface of the first sheet and the second surface of the second sheet is produced.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating a hardware configuration of an image forming apparatus according to a first embodiment.

FIG. 2 is a schematic diagram illustrating the image forming apparatus according to the first embodiment.

FIG. 3 is a diagram illustrating a buffer portion of a sheet processing apparatus according to the first embodiment.

FIGS. 4A to 4F are explanatory diagrams illustrating a heat-and-pressure bonding unit according to the first embodiment.

FIG. 5 is an example of a toner image formed by the image forming apparatus according to the first embodiment.

FIG. 6 is a diagram explaining a method for producing a double-page spread product in the first embodiment.

FIG. 7 is a flowchart illustrating a procedure for a double-page spread product production job in Comparative Example 1.

FIG. 8 is a flowchart illustrating a procedure for a double-page spread product production job in Example 1.

FIG. 9 is a flowchart illustrating a procedure for a double-page spread product production job in Example 2.

FIG. 10 is a schematic diagram illustrating an image forming apparatus according to a second embodiment.

FIG. 11 is a flowchart illustrating a procedure for a double-page spread product production job in the second embodiment.

FIG. 12 is a diagram explaining a method for producing a double-page spread product in a third embodiment.

### DESCRIPTION OF THE EMBODIMENTS

Hereinafter, with refence to drawings, embodiments according to this disclosure will be described.

In this disclosure, “image forming apparatus” includes a broad range of apparatuses that form (record) an image on a recording material (recording medium), such as single-function printers, copiers, multifunction machines, and commercial printing apparatuses. In addition, the image forming apparatus may be an image forming apparatus body that forms the image on the recording material, and a system (image forming system) in which apparatuses, such as sheet processing apparatuses and sheet conveyance apparatuses, are connected.

### First Embodiment

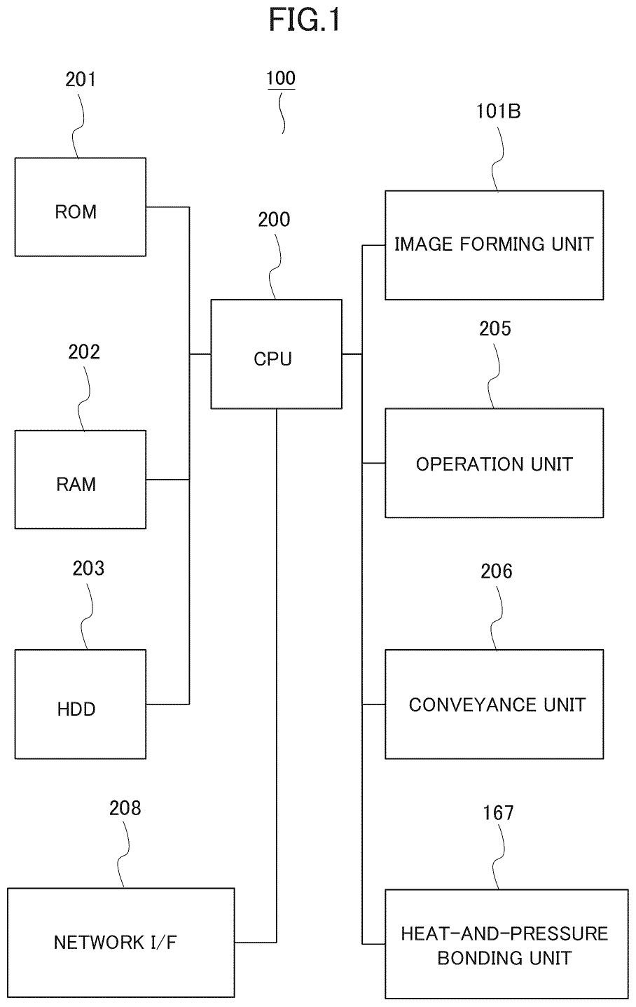

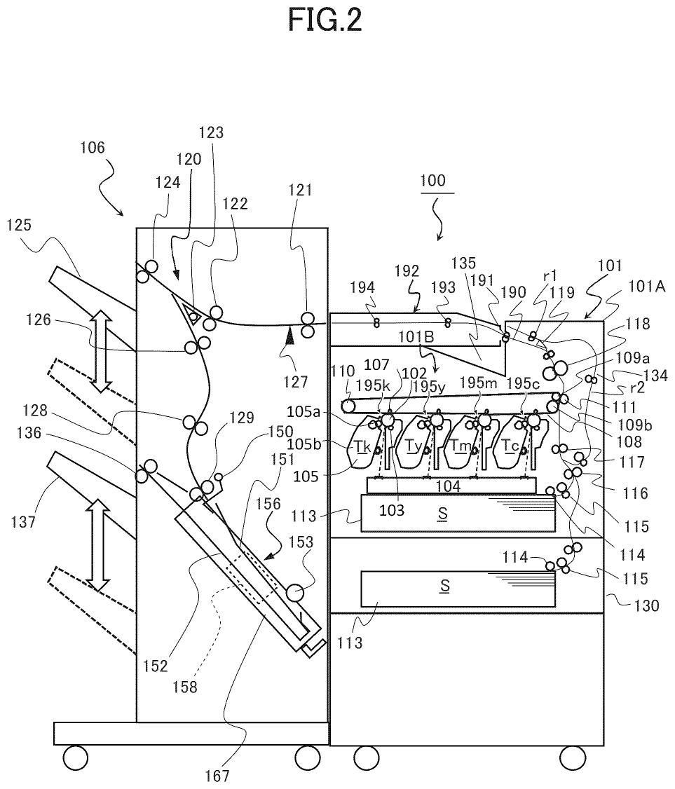

FIG. 1 is a block diagram illustrating a hardware configuration of an image forming apparatus 100 according to a first embodiment. FIG. 2 is a schematic diagram illustrating the image forming apparatus 100 according to the first embodiment.

As illustrated in FIG. 1, the image forming apparatus 100 includes a central processing unit (CPU) 200, a read only memory (ROM) 201, a random access memory (RAM) 202, a hard disk drive (HDD) 203, an image forming unit 101B, an operation unit 205, a conveyance unit 206, a heat-and-pressure bonding unit 167, and a network interface (I/F) 208.

The CPU 200 serves as a control unit (controller) that controls operations of the image forming apparatus 100. The CPU 200 is connected to the ROM 201, the RAM 202, and the HDD 203 via a bus, and executes various programs stored in the ROM 201; for example, performs an image forming operation. To be noted, some functions of the CPU 200 in this embodiment may be undertaken by control devices, such as a processor mounted in a sheet conveyance apparatus 106, other than the CPU 200. In such a case, the CPU 200, in conjunction with the control devices that collaborate with the CPU 200, forms the control unit (controller) that controls the operations of the image forming apparatus 100.

When performing the image forming operation, data that the CPU 200 uses are stored in the RAM 202. In HDD 203, for example, image information (printing data) that is to be formed on the recording material in the image forming operation is preserved. The operation unit 205 includes a display portion, such as a liquid crystal panel, that displays information with respect to a user, and an input portion that receives the input of setting information, a start request (print instruction) for the image forming operation, or the like from the user. The conveyance unit 206 includes conveyance members, such as conveyance rollers, that convey a sheet S, serving as the recoding material (recording medium, printing medium), and various motors that drive the conveyance members. The heat-and-pressure bonding unit 167 will be described below.

The CPU 200 receives the print data from an external computer connected via the network I/F 208, or receives the printing data from a document reading apparatus connected to the image forming apparatus 100. Upon receiving the print instruction via the external computer or the operation unit 205, the CPU 200 performs the image forming operation by controlling the respective loads (such as motors and power source boards) of the image forming unit 101B and the conveyance unit 206. In addition, based on the conditions specified by the user during the submission of the print instruction, the CPU 200 performs a heat-and-pressure bonding process (described below) using the heat-and-pressure bonding unit 167 as required.

As illustrated in FIG. 2, the image forming apparatus 100 includes a printer main body 101, serving as an image forming apparatus body equipped with an image forming function (printing function), and the sheet processing apparatus 106 incorporating a sheet bonding function. That is, the image forming apparatus 100 can be regarded as an image forming system that includes the printer main body 101, which independently functions as the image forming apparatus, and the sheet processing apparatus 106.

The image forming apparatus 100 of this embodiment is capable of forming the image on the sheet S one sheet at a time using the printer main body 101, performing a heat-and-pressure bonding on a plurality of sheets S in the sheet processing apparatus 106, and thereby producing an output product such as a booklet, with both printing and binding performed by a single image forming apparatus. To be noted, as for the sheet S, various types of sheet materials with differing sizes and materials can be used, including paper such as standard or thick paper, surface treated sheets such as coated paper, plastic films, cloth, or specially shaped sheets such as envelopes and index paper.

### Printer Main Body

The printer main body 101 is an electrophotographic apparatus including a casing 101A and the image forming unit 101B of an electrophotographic system enclosed within the casing 101A.

The image forming unit 101B includes an intermediate transfer belt 108, serving as an intermediate transfer member, a plurality of process cartridges arranged along the intermediate transfer belt 108, a scanner unit 104, serving as an exposure unit, and primary transfer rollers 107. In this embodiment, the image forming unit 101B includes four process cartridges 195y, 195m, 195c, and 195k corresponding to four colors: yellow, magenta, cyan, and black.

The process cartridge 195k forms a monochromatic image corresponding to a black component of a color image using a black toner Tk. The process cartridge 195y forms a monochromatic image corresponding to a yellow component of the color image using a yellow toner Ty. The process cartridge 195m forms a monochromatic image corresponding to a magenta component of the color image using a magenta toner Tm. The process cartridge 195c forms a monochromatic image corresponding to a cyan component of the color image using a cyan toner Tc.

The process cartridge 195k includes a photosensitive drum 102, serving as a photosensitive member, a charge unit 103, serving as a charge unit, and a developing unit 105, serving as a developing unit. While, in FIG. 2, only the process cartridge 195k is described with the above elements, the other process cartridges 195y to 195c have a similar structure.

The monochromatic images formed in each of the process cartridges 195y, 195m, 195c, and 195k are primarily transferred onto the intermediate transfer belt 108 in a manner overlapping each other, and subsequently transferred onto the sheet in a secondary transfer portion.

The developing unit 105 includes a developing roller 105a, serving as a developer bearing member, and a toner container 105b storing the toner (developer). The developing roller 105a is rotatably supported by the toner container 105b. While, in FIG. 2, only the developing unit 105 within the process cartridge 195k is described, developing units in the other process cartridges 195y to 195c have a similar structure.

The process cartridges 195y, 195m, 195c, and 195k can be attached and detached with respect to the casing 101A. The term “casing 101A” of the printer main body 101 refers to a portion of the printer main body 101 excluding the process cartridges 195. The casing 101A includes frame members such as metal frames, which constitute a frame body of the printer main body 101, and members secured to the frame body, and forms a mounting space in which the process cartridges 195 are mounted.

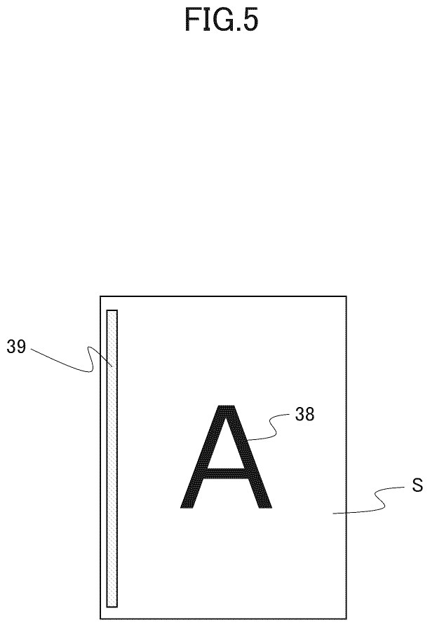

The printer main body 101 can use at least one of the toners of the plurality of colors as a toner for bonding the sheets to each other. For example, the black toner Tk can serve a dual function as a toner for recording the image on the sheet (printing toner) and as a toner for bonding (powder adhesive). In this case, the process cartridge 195k forms the monochromatic image corresponding to the black component of the color image and an adhesive toner image 39 (FIG. 5) for transfer onto a bonding region of the sheet.

Inside the casing 101A, the scanner unit 104, serving as the exposure unit, is arranged below the process cartridge 195. Beneath the scanner unit 104, a cassette 113 (sheet tray, also referred to as a storage compartment), serving as a storage portion for storing the sheet S used in image formation, is slidably mounted with respect to the casing 101A. Further, it is acceptable to connect equal to or more than one sheet feeding apparatus 130, which may include an additional cassette 113, under the casing 101A.

The intermediate transfer belt 108 is a movable (rotatable), endless belt that is stretched over a drive roller 109a, a stretch roller 109b, and a tension roller 110, which rotate around axes parallel to each other. The intermediate transfer belt 108 is moved (rotated, conveyed) in a counter-clockwise direction in FIG. 2 by the rotation of the drive roller 109a. On an inner circumferential side of the intermediate transfer belt 108, the primary transfer roller 107, serving as a primary transfer member, is arranged at a position facing the photosensitive drum 102 across the intermediate transfer belt 108. On an outer circumferential side of the intermediate transfer belt 108, at a position facing the drive roller 109a across the intermediate transfer belt 108, a secondary transfer roller 111, serving as a transfer member (secondary transfer member), is arranged. A secondary transfer portion, serving as a transfer portion, is formed as a nip portion between the intermediate transfer belt 108 and the secondary transfer roller 111.

The secondary transfer roller 111 is an example of the transfer member that transfers the toner image from the intermediate transfer belt 108, serving as an image bearing member, onto the sheet S. In addition, the intermediate transfer belt 108, the primary transfer roller 107, and the secondary transfer roller 111 form a transfer unit for transferring the toner image formed on the photosensitive drum 102 onto the sheet S.

Inside the casing 101A, a fixing unit 118 is arranged above the secondary transfer portion. The fixing unit 118 includes a configuration of a thermal fixing method that fixes the toner image through heating. The fixing unit 118 includes a heating member that heats the toner image on the sheet S, a pressing member that forms a nip portion (fixing nip) with the heating member, and a heat source that heats the heating member. Each of the heating and pressing members may be any of a roller, a tubular film, or an endless belt stretched over a plurality of rollers. The heat source can be, for example, a heater substrate with a pattern of resistive heating elements printed on a ceramic substrate, a halogen lamp emitting radiant heat, or a coil unit that induces heat in a conductive layer of a heating element through electromagnetic induction.

As an example, the fixing unit 118 includes a tubular film (heating member), a heater substrate arranged in an inner space of the film, and a pressing roller (pressing member) that forms the fixing nip with the film by coming into pressure contact with the heater substrate across the film. In this case, while nipping and conveying the sheet S in the fixing nip, the fixing unit 118 heats the toner image on the sheet S using the film whose temperature has been raised by the heat of the heater substrate.

In addition, in the casing 101A, various conveyance members constituting the conveyance unit 206 (FIG. 1) are arranged. In this embodiment, as the conveyance members, the printer main body 101 includes a feed roller 114, a separation roller pair 115, an extraction roller pair 116, a registration roller pair 117, and a sheet discharge roller pair 191.

### Image Forming Operation

In a case where the printer main body 101 performs the image forming operation, the sheet S is fed from the cassette 113 in a lower part of the casing 101A or the cassette 113 of the sheet feeding apparatus 130 by the feed roller 114, serving as a feed unit. The separation roller pair 115 conveys the fed sheet S while separating a single sheet from the fed sheets S if multiple sheets are simultaneously fed by the feed roller 114. This sheet S is conveyed toward the registration roller pair 117 by the extraction roller pair 116, and the skew of the sheet S is corrected when a leading edge of the sheet S abuts against a nip portion of the registration roller pair 117, which is in a halted state. The registration roller pair 117 delivers the sheet S to the secondary transfer portion at a timing synchronized with the formation of the toner image by the image forming unit 101B.

On the other hand, in the image forming unit 101B, the photosensitive drum 102 and the intermediate transfer belt 108 rotate, and the toner images are formed in each of the process cartridges 195y to 195k. The charge unit 103 uniformly charges a surface of the photosensitive drum 102. The scanner unit 104 writes an electrostatic laten image by emitting a laser beam to the photosensitive drum 102 based of the printing data representing the image to be recorded on the sheet S. This electrostatic latent image is developed (visualized) into the toner image through development by the developing unit 105 using the toner.

Here, in a case of performing the heat-and-pressure bonding described below by the sheet processing apparatus 106, the scanner unit 104 writes the electrostatic latent image by irradiating the photosensitive drum 102 with the laser beam based on information specifying a bonding position of the sheet S. When this electrostatic latent image is developed by the developing unit 105 using the toner, the adhesive toner image is formed on a surface region of the photosensitive drum 102 corresponding to a predetermined region (bonding region) on the sheet S.

The monochromatic images formed on each of the photosensitive drums 102 of the process cartridges 195y to 195k are primarily transferred to overlap each other on the intermediate transfer belt 108. Thereby, the toner image is formed on the intermediate transfer belt as a color image. By the rotation of the intermediate transfer belt 108, the color image is conveyed toward the secondary transfer portion. Then, in the secondary transfer portion, by applying a secondary transfer voltage to the secondary transfer roller 111, the toner image is transferred (secondarily transferred) onto the sheet S that is delivered from the registration roller pair 117. The sheet S that has passed through the secondary transfer portion is sent to the fixing unit 118, in which heat and pressure are applied to the toner image during its passage through the fixing nip, so that the toner is softened and then solidified. Thereby, the image is fixed on the sheet S.

A conveyance path of the sheet S passed through the fixing unit 118 is switched by a switching portion 119. In a case of one-sided printing, the sheet S is guided to a sheet discharge path 190 by the switching portion 119, and discharged from the casing 101A by the sheet discharge roller pair 191. In this embodiment, the printer main body 101 is connected to the sheet processing apparatus 106 via a relay conveyance unit 192. The sheet S discharged from the sheet discharge roller pair 191 is delivered to the sheet processing apparatus 106 via conveyance roller pairs 193 and 194 of the relay conveyance roller unit 192. In a case where the relay conveyance unit 192 and the sheet processing apparatus 106 are not connected, the sheet discharge roller pair 191 discharges the sheet S, serving as an output product, to a support tray 135 disposed on top of the casing 101A.

In a case of duplex printing, the sheet S, with the image formed on one side (front side), is guided to a reverse conveyance roller pair r1 by the switching portion 119. Then, once undergoing reverse conveyance (switchback conveyance) by the reverse conveyance roller pair r1, the sheet S is conveyed toward the registration roller pair 117 via a duplex conveyance path r2. The duplex conveyance unit 134, including the reverse conveyance roller pair r1 and the duplex conveyance path r2, serves as a reconveyance unit that reverses the sheet S, which has passed through the secondary transfer portion and the fixing unit 118, and conveys the reversed sheet S again toward the secondary transfer portion. Thereafter, when the sheet S passes through the secondary transfer portion and the fixing unit 118, the image is also formed on the other side (back side) of the sheet S, and then the sheet S is discharged from the casing 101A by the sheet discharge roller pair 191. In addition, as describe below, it is also possible to execute conveyance control to reverse the sheet S equal to or more than twice with the reverse conveyance roller pair r1 in the printer main body 101, and, after the sheet S passes through the secondary transfer portion and the fixing unit 118 equal to or more than three times, discharge the sheet S from the printer main body 101.

FIG. 5 is a diagram illustrating an example of the toner image that is formed on the sheet S. On the illustrated sheet S, a recording toner image 38 for recording images such as text, graphics, and photographs, and the adhesive toner image 39 for bonding the sheets to each other are formed. In the illustrated example, the adhesive toner image 39 is formed along one side (long side) of an A4-sized sheet S. The position, shape, area, and the like of the adhesive toner image 39 can be adjusted in accordance with a configuration of the heat-and-pressure bonding unit 167 described below.

### Sheet Processing Apparatus

The sheet processing apparatus 106 will be described. As illustrated in FIG. 2, the sheet processing apparatus 106 includes a buffer portion 120, serving as a buffer portion to preliminarily stack a plurality of sheets S, an intermediate supporting portion 156 to stack the plurality of sheets S, and the heat-and-pressure bonding unit 167 for applying heat and pressure to the sheets S for bonding the sheets S together. The heat-and-pressure bonding unit 167 is an example of a unit (binding unit) for binding the plurality of sheets S. The heat-and-pressure bonding unit 167 of this embodiment is a unit (bonding unit, heat-and-pressure bonding unit) for bonding the sheets to each other by heating and applying pressure to the sheet S that is coated with the adhesive toner as the adhesive. In addition, the sheet processing apparatus 106 includes a sheet discharge upper tray 125 and a sheet discharge lower tray 137, which can each ascend and descend, serving as sheet discharge destinations to discharge the output product of the image forming apparatus 100. The buffer portion 120, the intermediate supporting portion 156, and the heat-and-pressure bonding unit 167 will be described in detail below.

The sheet processing apparatus 106 receives the sheet S, on which the image has been formed by the printer main body 101, one sheet at a time, and, by performing a heat-and-pressure bonding process in a state in which the plurality of sheets S are stacked, can produce a bonded product. The bonded output product which the sheet processing apparatus 106 can produce includes a final output product (hereinafter referred to as a double-page spread product) where images are formed on facing surfaces of two sheets S and are bonded to form a double-page spread. In addition, the sheet processing apparatus 106 can produce a booklet with equal to or more than three sheets S bonded. In addition, the sheet processing apparatus 106 can discharge the sheet S, on which the image has been formed by the printer main body 101, to the sheet discharge upper or lower tray 125 or 137 without performing processing.

### Buffer Portion

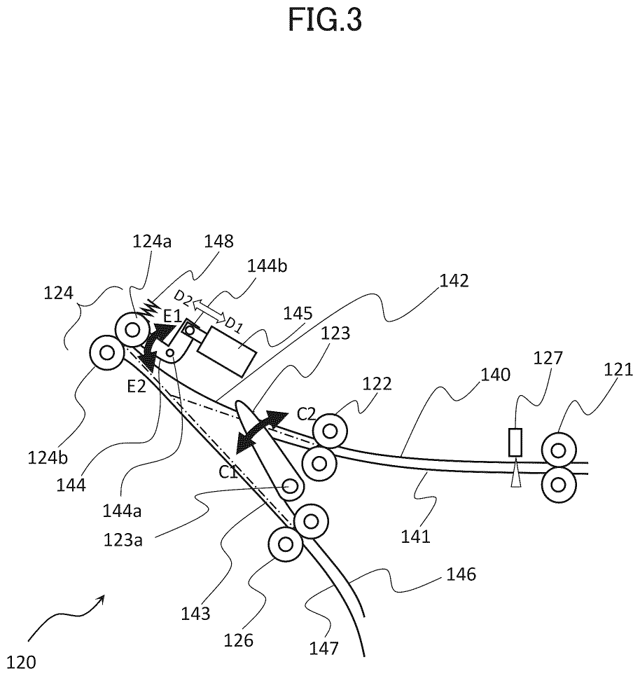

Using FIG. 3, the buffer portion 120 will be described. FIG. 3 is an enlarged view illustrating a cross-section of the buffer portion 120. The buffer portion 120 includes an inlet roller pair 121, a pre-buffer roller pair 122, a backflow prevention valve 123, a reverse conveyance roller pair 124, and an internal sheet discharge roller pair 126. In addition, the buffer portion 120 includes an inlet sensor 127 for detecting the sheet, and a separation mechanism including a plunger solenoid 145 or the like for opening and closing (engaging and disengaging) the reverse conveyance roller pair 124.

The inlet roller pair 121, the pre-buffer roller pair 122, the reverse conveyance roller pair 124, and the internal sheet discharge roller pair 126 each are roller pairs that convey the sheet by nipping the sheet. The inlet roller pair 121 and the pre-buffer roller pair 122 are arranged in a conveyance path (inlet path) for the sheet processing apparatus 106 to receive the sheet S. The reverse conveyance roller pair 124 is arranged in a conveyance path (first sheet discharge path, refer to FIG. 2) that communicates with the sheet discharge upper tray 125. The internal sheet discharge roller pair 126 is arranged in a conveyance path (internal sheet discharge path, refer to FIG. 2) extending from the reverse conveyance roller pair 124 toward the heat-and-pressure bonding unit 167. In addition, the sheet processing apparatus 106 includes a conveyance path (second sheet discharge path, refer to FIG. 2) extending from the heat-and-pressure bonding unit 167 toward the sheet discharge lower tray 137.

The inlet path is formed by an inlet upper guide 140 and an inlet lower guide 141. The first sheet discharge path is formed by a reverse conveyance upper guide 142 and a reverse conveyance lower guide 143. The internal sheet discharge path is formed by an internal sheet discharge upper guide 146 and an internal sheet discharge lower guide 147.

The inlet sensor 127 is arranged to detect the sheet received by the inlet roller pair 121. The inlet sensor 127 can use, for example, a reflective photo sensor that determines the presence and absence of the sheet by emitting the infrared light onto the inlet path through an opening disposed in the inlet upper guide 140 and detecting reflected light from the sheet. A hole larger than a spot diameter of the infrared light emitted by the inlet sensor 127 may be provided in the inlet lower guide 141 so as not to reflect the infrared light when the sheet does not pass through the inlet path.

The backflow prevention valve 123 is arranged downstream of the pre-buffer roller pair 122 with respect to a sheet conveyance direction in the inlet path. The backflow prevention valve 123 is arranged with respect to the internal sheet discharge guide 146 to rotate freely around a rotation shaft 123a as a center. The backflow prevention valve 123 can move to a first position, in which the sheet is prevented from moving from the first sheet discharge path to the inlet path (backflow), and a second position, in which the sheet is allowed to move from the inlet path to the first sheet discharge path. The backflow prevention valve 123 is urged from the second position toward the first position in a C2 direction by a spring, not shown. The backflow prevention valve 123 is configured to move from the first position toward the second position in a C1 direction when pressed by the sheet, and to return to the first position once the sheet has passed.

When viewed in a rotational axis direction of the backflow prevention valve 123, a tip portion of the backflow prevention valve 123 in the first position overlaps with the reverse conveyance upper guide 142. In addition, the tip portion of the backflow prevention valve 123 is formed in a comb-tooth shape to allow for overlapping with the reverse conveyance upper guide 142. In addition, when viewed in the rotational axis direction of the backflow prevention valve 123, a space allowing the passage of the sheet is formed between the backflow prevention valve 123 in the second position and the reverse conveyance upper guide 142.

The reverse conveyance roller pair 124 includes a reverse conveyance upper roller 124a and a reverse conveyance lower roller 124b, and drive is supplied to each roller. The rotation of the reverse conveyance upper and lower rollers 124a and 124b is configured to always be synchronized. In addition, a separation lever 144 is connected to the reverse conveyance upper roller 124a. The separation lever 144 is supported with respect to the reverse conveyance upper guide 142 to pivot freely around a lever fulcrum shaft 144a as a center. In addition, the separation lever 144 is rotatably connected to a plunger solenoid 145 at a solenoid connection shaft 144b.

When current flows through the plunger solenoid 145, since a core moves in a D1 direction in FIG. 3, the separation lever 144 pivots in an E1 direction in FIG. 3. In this case, the reverse conveyance roller pair 124 transitions to a disengaged state (a state in which a nip portion is opened) in which the reverse conveyance upper and lower rollers 124a and 124b are disengaged. When the current flowing through the plunger solenoid 145 is stopped, the reverse conveyance upper roller 124a moves in an E2 direction by an urging force of a compression spring 148, and the core of the plunger solenoid 145 moves in a D2 direction. In this case, the reverse conveyance roller pair 124 transitions to an engaged state (a state in which the nip portion is formed) in which the reverse conveyance upper and lower rollers 124a and 124b are engaged.

As described below, the buffer portion 120 performs an operation of stacking a newly conveyed sheet on top of the sheet (sheet bundle) while reciprocating the sheet (sheet bundle) between the reverse conveyance roller pair 124 and the internal sheet discharge roller pair 126. By this operation, the buffer portion 120 can send the sheets to the intermediate supporting portion 156 in a state in which the sheets are each stacked in a predetermined number (for example, five sheets) at a time.

As illustrated in FIG. 2, the sheet bundle stacked in the buffer portion 120 is conveyed from the internal sheet discharge roller pair 126 to a kick-out roller pair 129 via an intermediate conveyance roller pair 128. Then, by the kick-out roller pair 129, the sheet bundle is conveyed to the intermediate supporting portion 156 (processing tray) including an intermediate upper guide 151, an intermediate lower guide 152, and the like. In addition, to prevent a trailing edge of the sheet already stacked in intermediate supporting portion 156 from interfering with a leading edge of the sheet that is conveyed to the intermediate supporting portion 156, a bundle holding flag 150 that suppresses the lift of the trailing edge of the already stacked sheet is arranged downstream of the kick-out roller pair 129.

In the intermediate supporting portion 156, a vertical alignment roller 153 and a lateral alignment jogger 158, serving as an alignment unit, are arranged. The vertical alignment roller 153 conveys the sheet S in a direction along the sheet conveyance direction, and aligns the sheet S by abutting the leading edge of the sheet S against a reference abutment member. The lateral alignment jogger 158 presses one end of the sheet S in a sheet width direction, which is perpendicular to the sheet conveyance direction, and aligns the sheet S by abutting the other end of the sheet S against reference members (width alignment reference plates 172a and 172b, described below).

### Heat-and-Pressure Bonding Unit

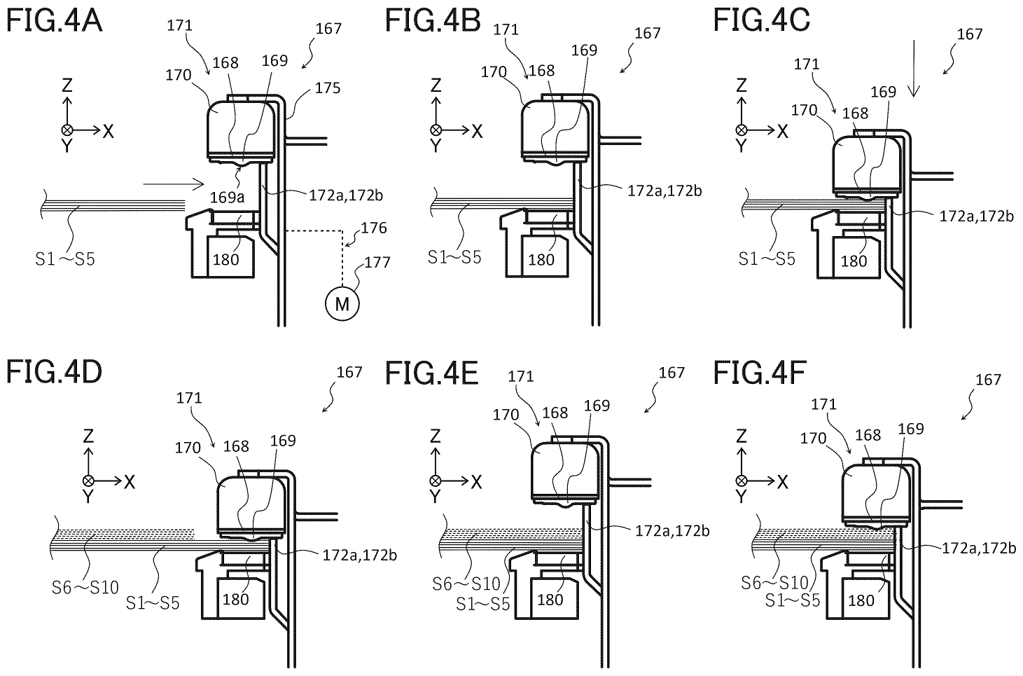

Using FIGS. 4A to 4F, a configuration and a heat-and-pressure bonding operation of the heat-and-pressure bonding unit 167 will be described. Each of FIGS. 4A to 4F is a diagram illustrating the heat-and-pressure bonding unit 167 when viewed in the sheet conveyance direction (Y direction).

As illustrated in FIG. 4A, the heat-and-pressure bonding unit 167 includes a heater unit 171 (heating unit), a pressure stay 175, a receiving plate 180, a pressure mechanism 176, and the width alignment reference plates 172a and 172b. The heat-and-pressure bonding unit 167 performs the heat-and-pressure bonding process, which is an example of a binding process to bind the plurality of sheets S by applying heat and pressure in a state of sandwiching the plurality of sheets S stacked in the intermediate supporting portion 156 between a pressure plate 169 and receiving plate 180.

The heater unit 171 includes the pressure plate 169, serving as a pressure member, a heater 168, serving as a heating unit, and a support member 170 supporting the pressure plate 169 and the heater 168. The support member 170 is supported by the pressure stay 175, and can move in a Z direction integrally with the pressure stay 175. The Z direction refers to a height direction (stack height direction, thickness direction) of the sheet bundle stacked in the intermediate supporting portion 156.

The receiving plate 180 is arranged to face the pressure plate 169 in the Z direction. The receiving plate 180 is formed of an elastic material such as, for example, heat-resistant silicone rubber, and is supported by a frame body of the heat-and-pressure bonding unit 167. The pressure mechanism 176 includes a motor 177 that serves as a drive source to reciprocate the pressure stay 175 in the Z direction and apply pressure on the sheet bundle.

Below, the heat-and-pressure bonding operation of the heat-and-pressure bonding unit 167 will be described, using a case where the heat-and-pressure bonding unit 167 produces a booklet of 10 sheets S1 to S10, as an example. In this example, each time five sheets, which are pre-stacked in the buffer unit 120, are stacked in the intermediate supporting portion 156, a single heat-and-pressure bonding operation is performed.

FIG. 4A illustrates a state in which the alignment of sheets S1 to S5 in the sheet conveyance direction (Y direction) has been completed. In this state, the heater unit 171 is in a position separated from the sheet bundle in the Z direction.

FIG. 4B illustrates a state in which the alignment of the sheets S1 to S5 in the sheet width direction (X direction) has been completed. The sheets S1 to S5 are aligned by being abutted against the width alignment reference plates 172a and 172b.

FIG. 4C illustrates a state in which the heater unit 171 was moved toward a pressing direction (−Z side) by the forward rotation of the motor 177 and a contact surface 169a (FIG. 4A) of the pressure plate 169 has come into contact with the uppermost sheet S5.

FIG. 4D illustrates a state in which, by further continuing the forward rotation of the motor 177, the sheets S1 to S5 are sandwiched between the pressure plate 169 and the receiving plate 180 and the heat-and-pressure bonding of the sheets S1 to S5 is underway. In addition, FIG. 4D illustrates a state in which, in parallel with the heat-and-pressure bonding of the sheets S1 to S5, subsequent sheets S6 to S10 have been conveyed to the intermediate supporting portion 156.

FIG. 4E illustrates a state, in which, after the heat-and-pressure bonding of the sheets S1 to S5 has been completed, the heater unit 171 is moved (retracted) in a direction (+Z side) opposite to the pressing direction by the reverse rotation of the motor 177, and the pressure plate 169 is separated from the sheet S5. In addition, FIG. 4E illustrates a state in which the alignment of the subsequent sheets S6 to S10 has been performed by being abutted against the width alignment reference plates 172a and 172b after the heater unit 171 was retracted.

FIG. 4F illustrates a state in which the heater unit has been again moved to the pressing direction (−Z side) by the forward rotation of the motor 177, the sheets S1 to S10 are sandwiched between the pressure plate 169 and the receiving plate 180, and the heat-and-pressure bonding of the sheets S6 to S10 is underway. Here, since the adhesive toner image is formed on an upper surface of the sheet S5 and/or a lower surface of the sheet S6, a lower sheet bundle (S1 to S5) and an upper sheet bundle (S6 to S10) are bonded to each other, and a single output product is formed.

As described above, by performing the heat-and-pressure bonding operation using the heat-and-pressure bonding unit 167 once each time the sheet bundle with the predetermined number of sheets is stacked and aligned in the intermediate supporting portion 156, it is possible to produce the output product that includes a larger number of sheets than the predetermined number. While, here, the example of producing the booklet that includes 10 sheets S1 to S10 is described, it is also possible to produce a booklet including several dozen sheets or more.

After completing the heat-and-pressure bonding of all sheets constituting the booklet, the booklet formed from the sheets S1 to S10 is extruded by an extrusion member from the intermediate supporting portion 156, and is conveyed toward a bundle discharge roller pair 136 (FIG. 2). The bundle discharge roller pair 136 is a roller pair that can open and close (can engage and disengage), and receives the booklet in a disengaged state. Upon receiving a leading edge of the booklet, the bundle discharge roller pair 136 transitions to an engaged state, and discharge the booklet to the sheet discharge lower tray 137 by nipping the booklet.

While the above describes the operation in a case of producing the booklet constituted by 10 sheets S1 to S10, the image forming apparatus 100 can produce the double-page spread product using two sheets S. The double-page spread product refers to the final output product in which the images are formed on the facing surfaces of two sheets S and these images are bonded to produce a double-page spread image.

In particular, the image forming apparatus 100 of this embodiment can divide a single input image into two images (first image, second image) for poster printing onto two sheets, and can produce the double-page spread product in which the first and second images are bonded to form the double-page spread image. By producing the double-page spread product in which the single input image is poster printed over the double-page spread, for example, two A4-sized sheets can be used as a pseudo A3-sized recording medium, and an output product with an A3-sized image printed on the double-page spread can be output.

In addition, the image forming apparatus 100 of this embodiment performs an inline process to execute a binding process (heat-and-pressure bonding process) subsequent to the image formation in the printer main body 101 using the sheet processing apparatus 106 connected to the printer main body 101. In other words, the image forming apparatus 100 can produce the double-page spread product by performing processes from the printing to the binding process in one-stop. However, the printer main body 101 and the sheet processing apparatus 106 may be configured as an independent offline system in which the user or the like transports the sheets discharged from the printer main body 101 to the sheet processing apparatus 106, and the binding process is performed on the sheets by the sheet processing apparatus 106.

### Image Size Deviation in Double-Page Spread Image

According to the image forming apparatus of this embodiment, by binding two sheets with the image formed on each sheet in a state in which the sheets are stacked to orient the images to face each other, it is possible to produce the output product with the image formed on the double-page spread. However, due to the shrinkage of the sheet caused by the heat received from the fixing unit, there is a possibility that an image size deviation may occur between the two sheets that constitute the double-page spread, and may subsequently lead to a decline in image quality on the double-page spread.

In particular, due to the heating during the passage through the fixing unit 118, the moisture contained in the sheet evaporates, and the shrinkage of the material occurs. Therefore, the size of the sheet S becomes slightly smaller after passing through the fixing unit 118 compared to the size before passing through the fixing unit 118. In addition, this phenomenon occurs when the sheet S passes through the fixing unit 118 for the first time, and the degree of the shrinkage is small when the sheet S passes through the fixing unit 118 for the second time or thereafter. The term “first” refers to the passage of the sheet S through the fixing unit 118 for the first time after being fed from the cassette 113 or the like.

Due to the shrinkage of the sheet S resulting from the heat application in the fixing unit 118 as described above, changes also occur in the size of the image (sizes in main scanning direction and sub-scanning direction) formed on the sheet S. In particular, a difference occurs in the image size after the fixing between a case where the toner image is transferred before the sheet S passes through the fixing unit 118 for the first time and a case where the toner image is transferred after the sheet S has already passed through the fixing unit 118.

More particularly, in the case where the toner image is transferred before the sheet S passes through the fixing unit 118 for the first time, the toner image is fixed on the sheet S when the sheet S passes through the fixing unit 118 for the first time. In this case, when the sheet S passes through the fixing unit 118 for the first time for fixing the toner image, not only does the sheet S shrink, but also the image transferred onto the sheet S shrinks in conjunction with the sheet S.

On the other hand, in the case where the toner image is transferred after the sheet S has already passed through the fixing unit 118, the toner image is transferred onto the sheet S that is in an already shrunken state. In this case, since the shrinkage of sheet S is small when the sheet S passes through the fixing unit 118 for the second time to fix the toner image, the shrinkage of the image is also negligible. To be noted, the same applies to cases where the toner image is transferred after the sheet S has passed through the fixing unit 118 more than twice.

Due to the reasons described above, when the image size difference occurs between the two sheets that constitute the double-page spread of the output product, on which the binding process has been performed by the heat-and-pressure bonding unit 167, the decline in the image quality of the double-page spread may be caused. In particular, this may result in the misalignment of lines drawn across the two sheets or asymmetry in the left-right balance of the images that span the two sheets. Thus, an impression that is not identical to the input image may be provided.

Therefore, in this embodiment, in a case of producing the double-page spread product, the likelihood of the difference in the image size is reduced by equalizing the number of times that each of the two sheets constituting the double-page spread passes through the fixing unit 118 before the transfer of the toner image. Hereinafter, specific methods for producing the output product will be described.

### Method for Producing Double-Page Spread Product

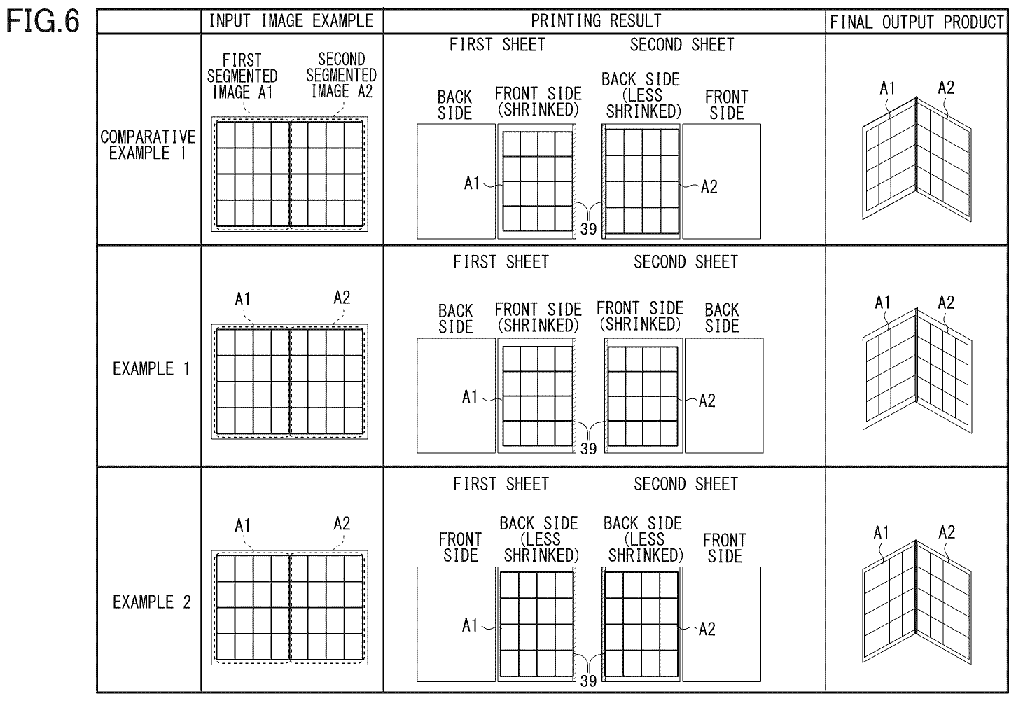

Next, the methods for producing the double-page spread product in this embodiment will be described. In FIG. 6, an input image example, printing results of each sheet, and final output products for Comparative Example 1, Example 1, and Example 2 are assembled. Example 1 and Example 2 each are an application example of this embodiment. The timing of processes such as performing the passage through the fixing unit 118 and the transfer of the toner image differs among Comparative Example 1, Example 1 and Example 2. Details will be described below.

The printing result illustrates a state of both surfaces of the sheet S at the time of being discharged from the printer main body 101 toward the sheet processing apparatus 106, and does not illustrate a state at the time of being discharged from the sheet processing apparatus 106. The final output product refers to the output product obtained as a result of the binding process of the first and second sheets.

A hatched area in the printing result and the final output product illustrates the adhesive toner image 39 (FIG. 5). In the case of producing the double-page spread product, the adhesive toner image 39 is formed along one side of the first sheet and one side of the second sheet, and the image corresponding to the input image is formed in an area that excludes the adhesive toner image 39. In this embodiment, it is possible to adhere A4-sized first and second sheets along their long sides. To be noted, if the adhesive toner image 39 is formed on at least one of the first and second sheets, the first and second sheets can be bonded.

The input image refers to the image (original image, document image) that the user instructs the image forming apparatus 100 to print. Here, a horizontally elongated grid image is used as an input image example. The final output product in a case of using this input image example is a double-page spread product in which the poster printing is performed such that a grid-patterned image corresponding to the left half of the input image and a grid-patterned image corresponding to the right half of the input image are respectively placed on the first and second sheets.

In a case where the size of the input image is equal to two output sheets (sheet S used for image formation) aligned side by side, the CPU 200 generates a set of two image data (first image data, second image data) by bisecting the input image. Then, the CPU 200 performs the image forming operation using the first and second image data.

In cases where the size of the input image is not equal to the two output sheets aligned side by side, the image can be bisected either horizontally or vertically and then scaled or resized to match the size of the output sheet for output. For example, if the input image is A3 size and the output sheet is A4 size, since the size of half the input image is equal to A4 size, the image is formed without scaling and resizing. On the other hand, if the input image is A4 size and the output sheet is also A4 size, the input image is magnified by enlarging the size of its original half (by a factor of the square root of 2, approximately 144%) to A4 size to form the image. In addition, the processing such as dividing and scaling of the image data may be performed by a dedicated chip different from the CPU 200.

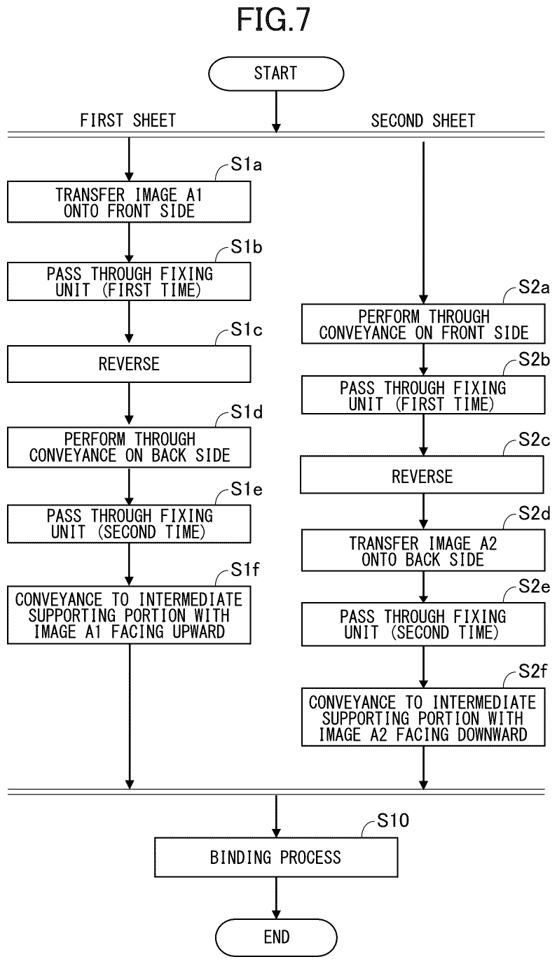

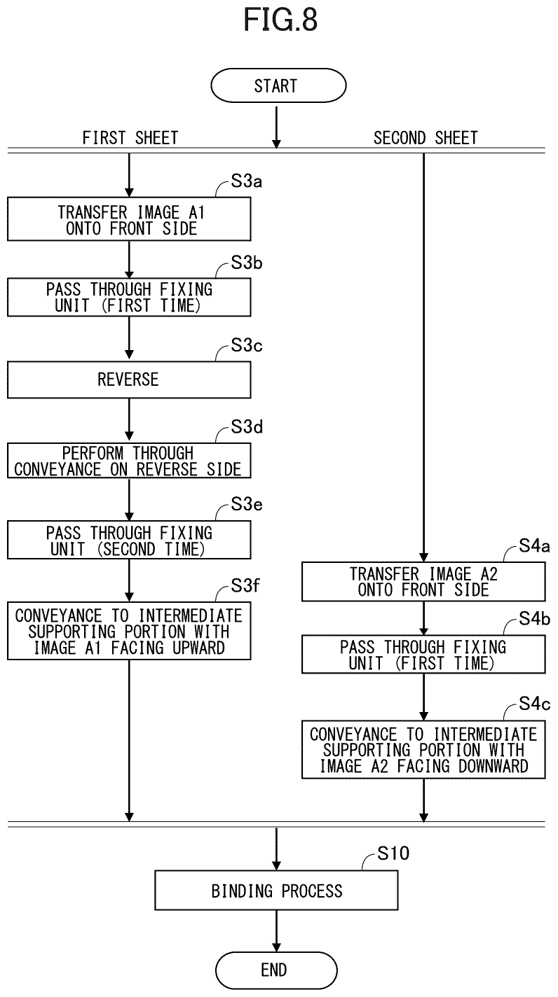

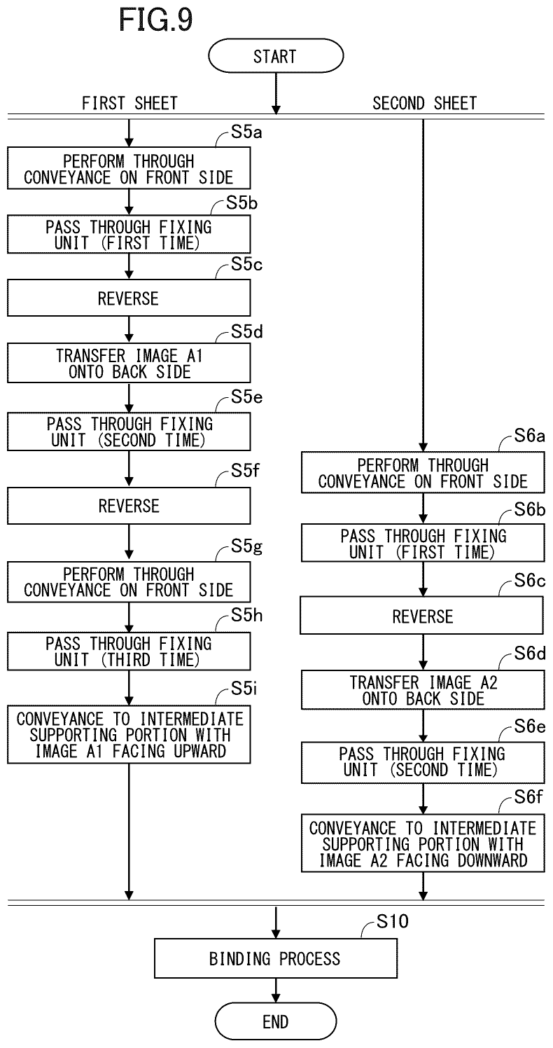

Hereinafter, the specific methods for producing the double-page spread product in Comparative Example 1, Example 1, and Example 2 will be described with reference to FIGS. 6 to 9. FIG. 7 is a flowchart illustrating a procedure for an image forming job to produce the double-page spread product (hereinafter referred to as a double-page spread product production job) in Comparative Example 1. FIG. 8 is a flowchart illustrating a procedure for a double-page spread product production job in Example 1. FIG. 9 is a flowchart illustrating a procedure for a double-page spread product production job in Example 2. Each step in the flowcharts of FIGS. 7 to 9 is executed by the CPU 200 (FIG. 1) operating the printer main body 101 and the sheet processing apparatus 106 in accordance with the program, unless otherwise specified.

In the description below, “front side” of the sheet S refers to a surface (image transfer surface) of the sheet S, which faces the intermediate transfer belt 108 (image bearing member) when the sheet S that is fed by the feed roller 114 (feed unit) passes through the secondary transfer portion for the first time. “Back side” of the sheet S refers to a surface of the sheet S, which faces the intermediate transfer belt 108 (image bearing member) when the sheet S passes through the secondary transfer portion for the second time via the duplex conveyance unit 134. To be noted, the “front side” and “back side” of the sheet S do not necessarily correspond to the front and back sides (front cover and back cover) of the final output product. The back side of the sheet S may alternatively be referred to as the side of the sheet S that is oriented toward a direction opposite to the intermediate transfer belt 108 when the sheet S passes through the secondary transfer portion for the first time. In addition, the front side of the sheet S is the side that faces the intermediate transfer belt 108 when the sheet S passes through the secondary transfer portion on an even-numbered occasion, and the back side of the sheet S is the side that faces the intermediate transfer belt 108 when the sheet S passes through the secondary transfer portion on an odd-numbered occasion.

In addition, in the description below, passing the sheet S through the secondary transfer portion without transferring any toner image onto the sheet S is referred to as “through conveyance”. In this embodiment, even in a case where the sheet S that has undergone the through conveyance at the secondary transfer portion passes through the fixing unit 118, the fixing unit 118 applies the heat to the sheet S in the same way as the case of fixing the toner image.

In addition, in the description below, images (i.e., tile images) divided and formed by the poster printing are referred to as a first segmented image A1 and a second segmented image A2, and the first and second segmented images A1 and A2 are collectively referred to as segmented images A1/A2. The first segmented image A1 is an image formed based on first image data in a case where a single input image is divided into the first image data and second image data. The second segmented image A2 is an image formed based on the second image data in the case where the single input image is divided into the first image data and the second image data.

In addition, in each of the flowcharts of FIGS. 7 to 9, a conveyance sequence of the first sheet and a conveyance sequence of the second sheet are executed in parallel. A positional relationship between each step in the vertical direction in the diagram roughly corresponds to a temporal sequence of the steps, and each step is executed from top to bottom. For example, in FIG. 7, the placement of STEP S2a below STEP S1b indicates that the second sheet passes through the secondary transfer portion after the first sheet has passed through the fixing unit 118. However, depending on the specific configuration of the image forming apparatus 100 and execution conditions of the job, the temporal sequence between a step of the conveyance sequence of the first sheet and a step of the conveyance sequence of the second sheet may vary.

### Comparative Example 1

As illustrated in an upper section of FIG. 6 and FIG. 7, in Comparative Example 1, while conveying the first and second sheets in a manner similar to conventional duplex printing, the images are formed on the front side of the first sheet and the back side of the second sheet. Then, the heat-and-pressure bonding process is performed in the sheet processing apparatus 106 such that the front side of the first sheet and the back side of the second sheet form the double-page spread.

In particular, the conveyance sequence of the first sheet in Comparative Example 1 is as follows. After causing feeding of the first sheet from the cassette 113, the CPU 200 causes the first segmented image A1 to be formed on the front side (STEP S1a), and then causes fixing of the first segmented image A1 when the first sheet passes through the fixing unit 118 for the first time (STEP S1b). After causing the reverse conveyance of the first sheet that has passed through the fixing unit 118 (STEP S1c), the CPU 200 causes the first sheet to pass through the secondary transfer portion without having any toner image transferred onto the back side of the first sheet (STEP S1d). Further, after causing the first sheet to pass through the fixing unit 118 for the second time (STEP S1e), the CPU 200 causes the first sheet to be conveyed to the intermediate supporting portion 156 of the sheet processing apparatus 106 (STEP S1f). The reverse conveyance is once performed after the first segmented image A1 has been formed on the front side, so that the first sheet is stacked in the intermediate supporting portion 156 with the first segmented image A1 facing upward.

On the other hand, the conveyance sequence of the second sheet in Comparative Example 1 is as follows. After causing feeding of the second sheet from the cassette 113, the CPU 200 causes the second sheet to pass through the secondary transfer portion without having a toner image transferred onto the front side of the second sheet (STEP S2a), and then causes the second sheet to pass through the fixing unit 118 (STEP S2b). After causing the reverse conveyance of the second sheet that has passed through the fixing unit 118 (STEP S2c), the CPU 200 causes transfer of the second segmented image A2 onto the back side of the second sheet (STEP S2d). Further, after causing fixing of the second segmented image A2 when the second sheet passes through the fixing unit 118 for the second time (STEP S2e), the CPU 200 causes the second sheet to be conveyed to the intermediate supporting portion 156 of the sheet processing apparatus 106 (STEP S2f). The second sheet is conveyed to the intermediate supporting portion 156 without undergoing the reverse conveyance after the second segmented image A2 has been formed on the back side thereof, so that the second sheet is stacked in the intermediate supporting portion 156 with the second segmented image A2 facing downward.

Then, with the first and second sheets stacked in the intermediate supporting portion 156 and the segmented images A1/A2 oriented to face each other, the CPU 200 causes the heat-and-pressure bonding on the edges of the first and second sheets using the heat-and-pressure bonding unit 167 (STEP S10). Through the above procedure, the final output product (upper section of right column of FIG. 6), in which the segmented images A1/A2 are placed on an inner side of the double-page spread of the two sheets that have been subject to the heat-and-pressure bonding by the heat-and-pressure bonding unit 167, is produced.

Here, in Comparative Example 1, while the first segmented image A1 is transferred onto the first sheet (STEP S1a) before the first sheet passes through the fixing unit 118 for the first time (STEP S1b), the second segmented image A2 is transferred onto the second sheet (STEP S2d) that has already passed through the fixing unit 118 once (STEP S2b). Therefore, while the first segmented image A1 shrinks in conjunction with a shrinkage of the first sheet when the first sheet passes through the fixing unit 118 for the first time, the second segmented image A2 hardly shrinks. As a result, as illustrated in the “printing result” and the “final output product” in FIG. 6, a difference in the image sizes may occur between the left and right pages of the double-page spread.

### Example 1

As illustrated in a central section of FIG. 6 and FIG. 8, in Example 1, both the first and second segmented images A1 and A2 are transferred onto the sheets that have not previously passed through the fixing unit 118.

In particular, the conveyance sequence of the first sheet in Example 1 is the same as the conveyance sequence of the first sheet in Comparative Example 1. That is, after feeding the first sheet from the cassette 113, the CPU 200 causes forming of the first segmented image A1 on the front side (STEP S3a), and fixing of the first segmented image A1 when the first sheet passes through the fixing unit 118 for the first time (STEP S3b). After causing the reverse conveyance of the first sheet that has passed through the fixing unit 118 (STEP S3c), the CPU 200 causes the first sheet to pass through the secondary transfer portion without having a toner image transferred onto the back side of the first sheet (STEP S3d). Further, after causing the first sheet to pass through the fixing unit 118 for the second time (STEP S3e), the CPU 200 causes the first sheet to be conveyed to the intermediate supporting portion 156 of the sheet processing apparatus 106 (STEP S3f). The reverse conveyance is once performed after the first segmented image A1 has been formed on the front side, so that the first sheet is stacked in the intermediate supporting portion 156 with the first segmented image A1 facing upward.

On the other hand, the conveyance sequence of the second sheet in Example 1 is as follows. After causing feeding of the second sheet from the cassette 113, the CPU 200 causes forming of the second segmented image A2 on the front side (STEP S4a) and fixing of the second segmented image A2 when the second sheet passes through the fixing unit 118 for the first time (STEP S4b). Then, without causing the reverse conveyance even once on the second sheet that has passed through the fixing unit 118, the CPU 200 causes the second sheet to be conveyed to the intermediate supporting portion 156 of the sheet processing apparatus 106 (STEP S4c). By being conveyed to the intermediate supporting portion 156 without undergoing the reverse conveyance after the second segmented image A2 has been formed on the front side, the second sheet is stacked in the intermediate supporting portion 156 with the second segmented image A2 facing downward.

Then, with the first and second sheets stacked in the intermediate supporting portion 156 and the segmented images A1/A2 oriented to face each other, the CPU 200 causes the heat-and-pressure bonding on the edges of the first and second sheet using the heat-and-pressure bonding unit 167 (STEP S10). Through the above procedure, the final output product (central section of right column of FIG. 6), in which the segmented images A1/A2 are placed on the inner side of the double-page spread of the two sheets that have been subject to the heat-and-pressure bonding by the heat-and-pressure bonding unit 167, is produced.

Here, in Example 1, first, the first segmented image A1 is transferred onto the first sheet before the first sheet passes through the fixing unit 118 for the first time (STEP S3b), and the second segmented image A2 is transferred onto the second sheet before the second sheet passes through fixing unit 118 for the first time (STEP S4b). Therefore, the first segmented image A1 shrinks in conjunction with shrinkage of the first sheet when the first sheet passes through the fixing unit 118 for the first time, and the second segmented image A2 shrinks in conjunction with shrinkage of the second sheet when the second sheet passes through the fixing unit 118 for the first time. As a result, as illustrated in the “printing result” and the “final output product” in the central section of FIG. 6, both the segmented images A1/A2 undergo slight shrinkage in comparison with the time of the transfer, and the difference in the image dimensions between the left and right pages of the double-page spread can be avoided.

In other words, in Example 1, the control unit performs the following control in the case of producing the output product in which the first and second images are formed on the double-page spread constituted by the first and second sheets. Before the first sheet passes through the fixing unit for the first time, the control unit causes transfer of the first image onto the first sheet by the transfer member, and causes fixing of the first image on the first sheet by the fixing unit. In addition, before the second sheet passes through the fixing unit for the first time, the control unit causes transfer of the second image onto the second sheet by the transfer member, and causes fixing of the second image on the second sheet by the fixing unit. Further, the control unit causes conveyance of the first and second sheets to the binding unit such that the first and second images face each other, and causes binding of the first and second sheets by the binding unit.

According to the present embodiment, an image forming apparatus and a method for producing a product, which are capable of suppressing a difference in image size between images in a product, can be provided. Further, an image forming apparatus capable of suppressing a difference in image size on a double-page spread can be provided.

In addition, in Example 1, when comparing with Example 2 described below, the first sheet requires a reduced number of reverse conveyance. Therefore, it is possible to shorten the time from initiation of the double-page spread product production job to the output of the final output product, and is possible to improve the productivity of the image forming apparatus 100.

### Example 2

As illustrated in a lower section of FIG. 6 and FIG. 9, in Example 2, both the first and second segmented images A1 and A2 are transferred onto the sheets that have passed through the fixing unit 118 at least once.

In particular, the conveyance sequence of the first sheet in Example 2 is as follows. After causing feeding of the first sheet from the cassette 113, the CPU 200 causes the first sheet to pass through the secondary transfer portion without having any toner image transferred on the front side of the first sheet (STEP S5a), and then pass through the fixing unit 118 (STEP S5b). After causing the reverse conveyance of the first sheet that has passed through the fixing unit 118 (STEP S5c), the CPU 200 causes transfer of the first segmented image A1 onto the back side of the first sheet (STEP S5d), and fixing of the first segmented image A1 when the first sheet passes through the fixing unit 118 for the second time (STEP S5e). After causing the reverse conveyance of the first sheet that has passed through the fixing unit 118 for the second time (STEP S5f), the CPU 200 causes the first sheet to pass through the secondary transfer portion without having any toner image transferred onto the first sheet (STEP S5g). Further, after causing the first sheet to pass through the fixing unit 118 for the third time (STEP S5h), the CPU 200 causes conveyance of the first sheet to the intermediate supporting portion 156 of the sheet processing apparatus 106 (STEP S5i). The reverse conveyance is once performed after the first segmented image A1 has been formed on the front side, so that the first sheet is stacked in the intermediate supporting portion 156 with the first segmented image A1 facing upward.

On the other hand, the conveyance sequence of the second sheet in Example 2 is the same as the conveyance sequence of the second sheet in Example 1. That is, after causing feeding the second sheet from the cassette 113, the CPU 200 causes the second sheet to pass through the secondary transfer portion without having the toner image transferred onto the front side of the second sheet (STEP S6a), and then pass through the fixing unit 118 (STEP S6b). After causing the reverse conveyance on the second sheet that has passed through the fixing unit 118 (STEP S6c), the CPU 200 causes transfer of the second segmented image A2 onto the back side of the second sheet (STEP S6d). Further, after causing fixing of the second segmented image A2 when the second sheet passes through the fixing unit 118 for the second time (STEP S6e), the CPU 200 causes conveyance of the second sheet to the intermediate supporting portion 156 of the sheet processing apparatus 106 (STEP S6f). The second sheet is conveyed to the intermediate supporting portion 156 without undergoing the reverse conveyance after the second segmented image A2 has been formed on the back side, so that the second sheet is stacked in the intermediate supporting portion 156 with the second segmented image A2 facing downward.

Then, with the first and second sheets stacked in the intermediate supporting portion 156 and the segmented images A1/A2 oriented to face each other, the CPU 200 causes the heat-and-pressure bonding on the edges of the first and second sheet using the heat-and-pressure bonding unit 167 (STEP S10). Through the above procedure, the final output product (lower section of right column of FIG. 6), in which the segmented images A1/A2 are placed on the inner side of the double-page spread of the two sheets that have been subject to the heat-and-pressure bonding by the heat-and-pressure bonding unit 167, is produced.

Here, in Example 2, the first and second segmented image A1 and A2 are transferred onto the first and second sheets that have passed through the fixing unit 118 at least once (STEPS S5b, S6b). In other words, the first segmented image A1 is transferred onto the first sheet that is in an already shrunken state, and the second segmented image A2 is transferred onto the second sheet that is in the already shrunken state. Therefore, when the first and second sheets pass through the fixing unit 118 for the second time to fix the image, the first and second sheets undergo less shrinkage, and the sizes of the segmented images A1/A2 are less likely to become smaller compared to the time of the transfer. As a result, as illustrated in the “printing result” and the “final output product” in the lower section of FIG. 6, both the segmented images A1/A2 are output at substantially the same size, and the difference in the image sizes between the left and right pages of the double-page spread can be avoided.

In other words, in Example 2, in the case of producing the double-page spread product in which the first and second images are formed on the double-page spread constituted by the first and second sheets, the control unit performs control as follows. The control unit causes transfer of the first image onto the first sheet by the transfer member after the first sheet has passed through the fixing unit at least once, and causes fixing of the first image on the first sheet by the fixing unit. In addition, the control unit causes transfer of the second image onto the second sheet by the transfer member after the second sheet has passed through the fixing unit at least once, and causes fixing of the second image on the second sheet by the fixing unit. Further, the control unit causes conveyance of the first and second sheets to the binding unit such that the first and second images are oriented to face each other, and causes binding of the first and second sheets by the binding unit.

According to the present embodiment, an image forming apparatus and a method for producing a product, which are capable of suppressing a difference in image size between images in a product, can be provided. Further, an image forming apparatus capable of suppressing a difference in image size on a double-page spread can be provided.

In addition, according to Example 2, with respect to each of the first and second sheets, the CPU 200 causes the through conveyance when the sheet passes through the secondary transfer portion for the first time, and causes the transfer of the image after the reverse conveyance by the duplex conveyance unit 134. That is, the control unit causes the first sheet to pass through the transfer member and the fixing unit for the first time without having any toner image formed on a first surface (front side) of the first sheet that has been fed by the feed unit, and, thereafter, causes the reverse conveyance on the first sheet by the reconveyance unit. In addition, when the first sheet passes through the transfer member for the second time, the control unit causes transfer of the first image on a second surface (back side) opposite to the first surface of the first sheet by the transfer member. In addition, after the second sheet fed by the feed unit passes through the transfer member and the fixing unit for the first time without having any toner image formed on a third surface (front side) of the second sheet, the control unit causes the reverse conveyance on the second sheet by the reconveyance unit. In addition, when the second sheet passes through the transfer portion for the second time, the control unit causes transfer of the second image onto a fourth surface (back side) opposite to the third surface of the second sheet by the transfer member.

With this configuration, for the following reasons, further improvement in the image quality in the final output product can be achieved compared to Example 1. That is, in Example 1, since the first and second sheets pass through the fixing unit 118 for their first time after the transfer of the segmented images A1/A2, the size of the segmented images A1/A2 on the final output product is reduced compared to the size of the segmented images A1/A2 at the time of the transfer. In addition, in a case where there is a difference in a shrinkage amount between the first and second sheets as they pass through the fixing unit 118 for their first time, or in a case where there is uneven shrinkage within a single sheet, there is a possibility that a difference in the size, misalignment, distortion, or the like of the segmented images A1/A2 may occur. In contrast, in Example 2, the segregated image A1/2 is transferred onto the first and second sheets, which are in the already shrunken state when the first and second sheets pass through the fixing unit 118 for their first time, and almost no shrinkage occurs on the first and second sheets after the transfer of the segregated image A1/2. Therefore, it is possible to further suppress a size difference between the segmented images A1/A2, and is possible to achieve the further improvement in the image quality in the final output product.

In addition, according to Example 2, the number of times (e.g., once) the first sheet passes through the fixing unit 118 before the first segmented image A1 (first image) is transferred onto is equal to the number of times (e.g., once) the second sheet passes through the fixing unit 118 before the second segmented image A2 (second image) is transferred onto. Therefore, for example, it is possible to avoid the occurrence of a small size difference between the segmented images A1/A2 due to a slight shrinkage during the passage of the sheet through the fixing unit 118 for the second time. To be noted, the number of times the first sheet passes through the fixing unit 118 before the first segmented image A1 is transferred onto the first sheet and the number of times the second sheet passes through the fixing unit 118 before the second segmented image A2 is transferred onto the second sheet may be equalized to two times (or a predetermined number of times more than two).

### Modified Example 1

In Example 1 and Example 2, after the first segmented image A1 has been fixed by the fixing unit 118, the reverse conveyance is performed using the duplex conveyance unit 134 (reconveyance unit) such that the segmented images A1/A2 are oriented to face each other in the heat-and-pressure bonding unit 167. After the first sheet passes through the secondary transfer portion and the fixing unit 118 again, the first sheet is conveyed to the heat-and-pressure bonding unit 167. This is because, if the first sheet, on which the first segmented image A1 is fixed by the fixing unit 188, is conveyed to the heat-and-pressure bonding unit 167 without undergoing the reverse conveyance, the first segment image A1 faces downward in the intermediate supporting portion 156. In other words, it is because the image forming apparatus 100 of this embodiment employs a configuration (face-down configuration) in which the image transfer surface of the sheet S, immediately before the sheet S is discharged from the printer main body 101, faces downward in the intermediate supporting portion 156. The image transfer surface refers to a sheet surface that faces the image bearing member (intermediate transfer belt 108) when the sheet S passes through the secondary transfer portion,

As a modified example, in a configuration (face-up configuration) in which the image transfer surface immediately before the sheet S is discharged from the printer main body 101 faces upward in the intermediate supporting portion 156, additional reverse conveyance is performed on the second sheet instead of the first sheet.

In the case of the face-up configuration, for example, in Example 1 (FIG. 8), the first sheet that has passed through the fixing unit 118 for the first time (STEP S3b) is conveyed to the intermediate supporting portion 156 without undergoing the reverse conveyance. In addition, the second sheet that has passed through the fixing unit 118 for the first time (STEP S4b) undergoes the reverse conveyance by the duplex conveyance unit 134. After passing through the secondary transfer portion and the fixing unit 118 again, the second sheet is conveyed to the heat-and-pressure bonding unit 167. Thereby, it is possible to orient the first segmented image A1 of the first sheet and the second segmented image A2 of the second sheet to face each other in the heat-and-pressure bonding unit 167. Also, in the case of Example 2 (FIG. 9), the second sheet passed through the fixing unit 118 for the second time (STEP S6e) undergoes the reverse conveyance by the duplex conveyance unit 134 to pass through the secondary transfer portion and the fixing unit 118 again. Then, the second sheet can be conveyed to the heat-and-pressure bonding unit 167.

### Modified Example 2

While, in the first embodiment, any image is not formed on the back side of the segmented images A1/A2 in the double-page spread, an image may be formed on the back side of the segmented images A1/A2 in the double-page spread. That is, the image may be formed on outer surfaces of the first and second sheets in the state bonded in the heat-and-pressure binding unit 167. In other words, in a case of producing the double-page spread product, it is acceptable that, by transferring a third image onto the opposite side of a surface on which the first image of the first sheet is formed and transferring a fourth image onto the opposite side of a surface on which the second image of the second sheet is formed, the control unit can perform a job for producing the output product in which the third and fourth images are formed on the back side of the double-page spread.

In this case, conveyance of the first and second sheets can be controlled such that the number of times the first sheet passes through the fixing unit 118 before the transfer of the third image equals the number of times the second sheet passes through the fixing unit 118 before the transfer of the fourth image. Thereby, size difference between the third and fourth images can be reduced. For example, in Example 2 (FIG. 9), instead of the through conveyance of the front sides in the first and second sheets (STEPS S5d and S6b), the third image is transferred onto the front side of the first sheet, and the fourth image is transferred onto the front side of the second sheet. Thereby, the number of times the first sheet passes through the fixing unit 118 before the transfer of the third image (0 times) and the number of times the second sheet passes through the fixing unit 118 before the transfer of the fourth image (0 times) can be equalized.

To be noted, the conveyance of the first and second sheets may be controlled such that both the number of times the first sheet passes through the fixing unit 118 before the transfer of the third image and the number of times the second sheet passes through the fixing unit 118 before the transfer of the fourth image become equal to or more than once. In addition, the third and fourth images may be segmented images of a single input image, or may be images corresponding to two separate input images.

### Second Embodiment

In the first embodiment, in the case of producing the double-page spread, by performing additional reverse conveyance on the first or second sheet after the image has been transferred, the first and second sheets are conveyed to the heat-and-pressure bonding unit 167 in the state in which the sheet surfaces constituting the double-page spread are oriented to face each other. However, if the first and second sheets are conveyed such that the sheet surfaces constituting the double-page spread are oriented to face each other in the heat-and-pressure bonding unit 167 (binding unit), it is not always necessary to perform the additional reverse conveyance on the sheet after the image has been transferred.

Hereinafter, as a second embodiment, a configuration which enables the production of the double-page spread product by switching a conveyance route of each sheet after the image has been transferred will be described. Here, a configuration adopting this embodiment will be described using Example 2 of the first embodiment as a basis. Elements marked with reference characters common to the first embodiment are assumed to have essentially the same configurations and functions as those described in the first embodiment, unless otherwise specified, and the differences from the first embodiment will be primarily described.

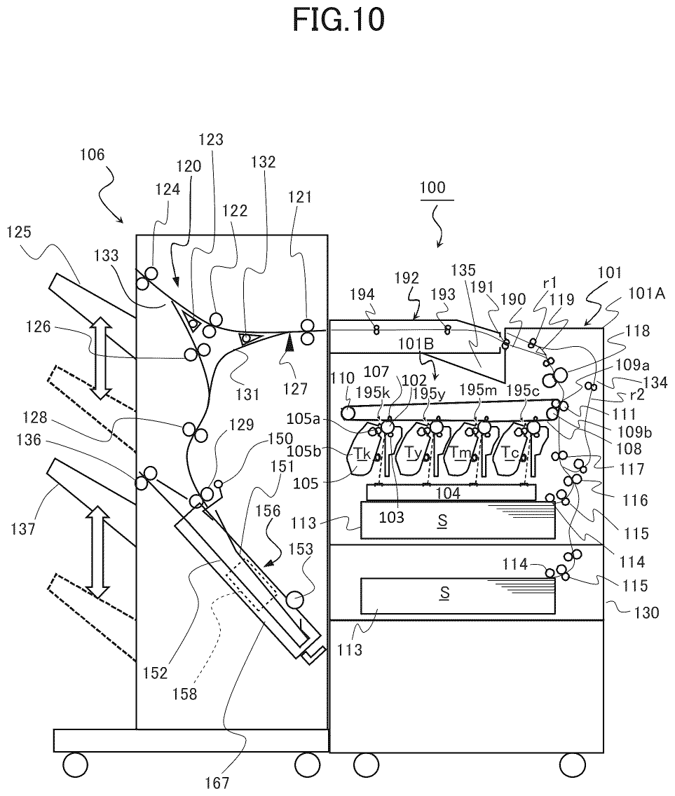

FIG. 10 is a schematic diagram illustrating the image forming apparatus 100 according to the second embodiment. The image forming apparatus 100 of this embodiment is different from the first embodiments due to the inclusion of a shortcut path 131 and a switching guide 132 disposed inside the sheet processing apparatus 106.

The shortcut path 131 branches from the inlet path downstream of the inlet roller pair 121, and merges with the internal sheet discharge path between the internal sheet discharge roller pair 126 and the intermediate conveyance roller pair 128. A conveyance path from the inlet roller pair 121 to the intermediate conveyance roller pair 128 via the pre-buffer roller pair 122, the reverse conveyance roller pair 124, and the internal sheet discharge roller pair 126 is referred to as a reverse conveyance path 133. The reverse conveyance path 133 and the shortcut path 131 are examples of a first conveyance path and a second conveyance path that branch midway on a path from the fixing unit 118 (fixing unit) to the heat-and-pressure bonding unit 167 (binding unit) in the image forming apparatus 100. The reverse conveyance path 133 is the example of the first conveyance path in which the sheet S undergoes the reverse conveyance, and the shortcut path 131 is the example of the second conveyance path in which the sheet is conveyed without being reversed. In addition, the reverse conveyance path 133 and the shortcut path 131 are the examples of the first and second conveyance paths which branch at a branch portion further downstream than the fixing unit 118 in the sheet conveyance direction and merge at a merging portion upstream of the heat-and-pressure bonding unit 167. Here, the sheet conveyed through the first conveyance path undergoes the reverse conveyance on a way from the branch portion to the merging portion, and the sheet conveyed through the second conveyance path is conveyed from the branch portion to the merging portion without being reversed.

The switching guide 132 is arranged in the branch portion at which the reverse conveyance path 133 branches from the shortcut path 131. The switching guide 132 can move to a position at which the sheet S delivered from the inlet roller pair 121 is guided to the reverse conveyance path 133, and a position at which the sheet S delivered from the inlet roller pair 121 is guided to the shortcut path 131. The switching guide 132 is an example of a switching member that switches a conveyance route of the sheet S between the reverse conveyance path 133 (first conveyance path) and the shortcut path 131 (second conveyance path).

In this embodiment, in the case of producing the double-page spread product, the CPU 200 (FIG. 1) controls the conveyance route of the first sheet and that of the second sheet using the switching guide 132 such that the sheet surfaces constituting the double-page spread are oriented to face each other in the heat-and-pressure bonding unit 167 (binding unit).

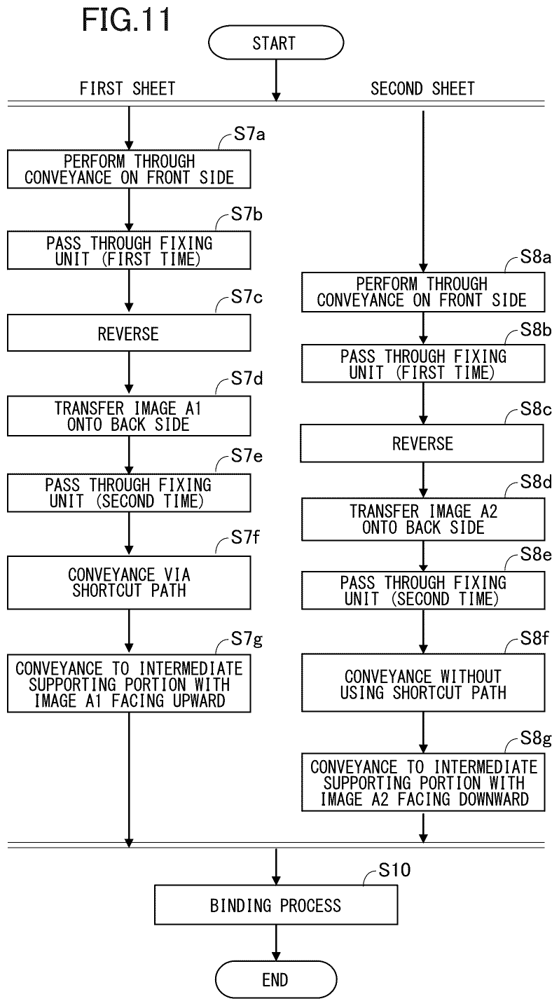

FIG. 11 is a flowchart illustrating a procedure for the double-page spread product production job in the second embodiment. Hereinafter, a specific control example will be described along the flowchart.

A conveyance sequence of the first sheet in the second embodiment is as follows. After causing feeding of the first sheet from the cassette 113, the CPU 200 causes the first sheet to pass through the secondary transfer portion without having any toner image transferred on the front side of the first sheet (STEP S7a) and to pass through the fixing unit 118 (STEP S7b). After causing the reverse conveyance on the first sheet that has passed through the fixing unit 118 (STEP S7c), the CPU 200 causes transfer of the first segmented image A1 onto the back side of the first sheet (STEP S7d), and causes fixing of the first segmented image A1 when the first sheet passes through the fixing unit 118 for the second time (STEP S7e). The CPU 200 causes the first sheet to be conveyed to the sheet processing apparatus 106 without being subject to the reverse conveyance, and causes conveyance of the first sheet via the shortcut path 131 (STEP S7f) and staking of the first sheet in the intermediate supporting portion 156 (STEP S7g). By being conveyed without undergoing the reverse conveyance and via the shortcut path 131 after the first segmented image A1 has been formed on the back side, the first sheet is stacked in the intermediate supporting portion 156 with the first segmented image A1 facing upward.

On the other hand, a conveyance sequence of the second sheet in the second embodiment is as follows. After causing feeding of the second sheet from the cassette 113, the CPU 200 causes the second sheet to pass through the secondary transfer portion without having any toner image transferred onto the front side of the second sheet (STEP S8a) and pass through the fixing unit 118 (STEP S8b). After causing the reverse conveyance on the second sheet that has passed through the fixing unit 118 (STEP S8c), the CPU 200 causes transfer of the second segmented image A2 onto the back side of the second sheet (STEP S8d). Further, after causing fixing of the second segmented image A2 when the second sheet passes through the fixing unit 118 for the second time (STEP S8e), the CPU 200 causes the second sheet to be conveyed to the sheet processing apparatus 106 without being subject to the reverse conveyance on the second sheet. Then, the CPU 200 causes conveyance of the second sheet not via the shortcut path 131 but via the reverse conveyance path 133 (STEP S8f), and causes stacking of the second sheet in the intermediate supporting portion 156 (STEP S8g). By being conveyed in a state of being reversed in the reverse conveyance path 133 after the second segmented image A2 has been formed on the back side, the second sheet is stacked in the intermediate supporting portion 156 with the second segmented image A2 facing downward.

Then, in a state in which the first and second sheets are stacked in the intermediate supporting portion 156 with the segmented images A1/A2 oriented to face each other, the CPU 200 causes the heat-and-pressure bonding on the edges of the first and second sheets using the heat-and-pressure bonding unit 167 (STEP S10). Through the above procedure, the final output product (upper section of right column of FIG. 6), in which the segmented images A1/A2 are placed on the inner side of the double-page spread of the two sheets that have been subject to the heat-and-pressure bonding by the heat-and-pressure bonding unit 167, is produced.

Also in this embodiment, between the sheets constituting the double-page spread, the number of times the sheets pass through the fixing unit 118 before the toner image is transferred is equalized. Therefore, an image forming apparatus and a method for producing a product, which are capable of suppressing a difference in image size between images in a product, can be provided. Further, an image forming apparatus capable of suppressing a difference in image size on a double-page spread can be provided.

In addition, in comparison with the first embodiment, the sheet surfaces that constitute the double-page spread can be made to face each other in the heat-and-pressure bonding unit 167 (binding unit) without performing additional reverse conveyance on the first or second sheet after the image has been transferred. Therefore, for example, in comparison with Example 2 of the first embodiment, it is possible to shorten the time from initiating the double-page spread product production job to the discharge of the final sheet from the printer main body 101, and is possible to improve the productivity of the printer main body 101. In addition, since it is possible to shorten the time from initiating the double-page spread product creation job to the output of the final output product, it is possible to improve the productivity of the entire image forming apparatus 100.

### Modified Example

FIG. 11 illustrates the example of the application of the conveyance control utilizing the shortcut path 131, using Example 2 of the first embodiment as a basis. It is not limited to this, and Example 1 (FIG. 8) of the first embodiment and the conveyance control utilizing the shortcut path 131 may be combined. In particular, in the conveyance sequence of the first sheet in Example 1, the first sheet having the first segmented image A1 transferred onto the front side thereof and passed through the fixing unit 118 (STEP S3b) can be conveyed to the intermediate supporting portion 156 via the shortcut path 131 without undergoing the reverse conveyance. The conveyance sequence of the second sheet can be the same as Example 1. Even by this method, the first sheet can be conveyed to the intermediate supporting portion 156 with the first segment image A1 facing upward. In addition, the productivity of the image forming apparatus 100 can be improved compared to Example 1.

In addition, in the second embodiment, exemplified is the configuration in which the first conveyance path (reverse conveyance path 133) for reversing and conveying the sheet and the second conveyance path (shortcut path 131) for conveying the sheet without reversing are arranged inside the sheet processing apparatus 106. It is not limited to this, and, for example, the first and second conveyance paths may be arranged in the printer main body 101 or the relay conveyance unit 192.

### Third Embodiment

In the first embodiment, the configuration for producing the double-page spread product by assigning and printing one input image onto two sheets is described. As a third embodiment, a case of producing the double-page spread product by printing two input images on two sheets will be described. Hereinafter, elements marked with reference characters common to the first embodiment are assumed to have essentially the same configurations and functions as those described in the first embodiment, unless otherwise specified, and the differences from the first embodiment will be primarily described.

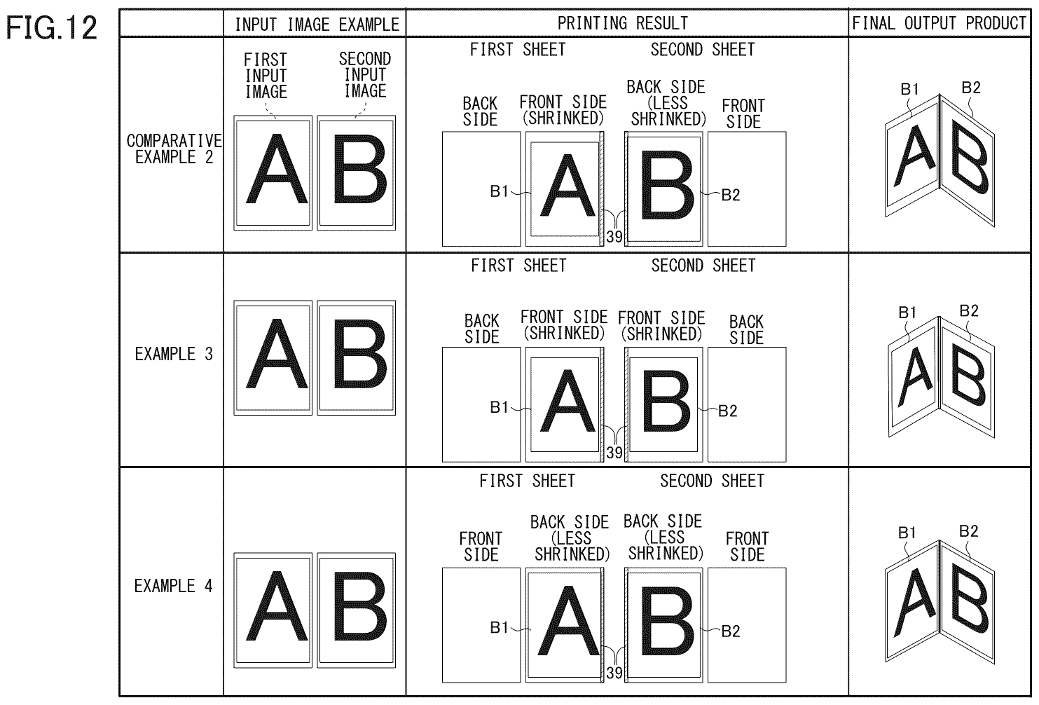

Hereinafter, specific production methods for the double-page spread product in Comparative Example 2, Example 3, and Example 4 will be described using FIG. 12. FIG. 12 illustrates an input image example, printing results for each sheet, and final output products in Comparative Example 2, Example 3, and Example 4. Example 3 and Example 4 are application examples of this embodiment.

In this embodiment, two image data (first input image, second input image) are input to the image forming apparatus 100. The first input image is image data representing a first image that is formed on one side of the double-page spread, and the second input image is image data representing a second image that is formed on the other side of the double-page spread. That is, in this embodiment, the poster printing in which one input image is divided and formed onto a plurality of sheets is not performed. In other words, in this embodiment, in a case where it is instructed to form the first and second input images on different sheets, the control unit causes the first image to be formed on the first sheet based on the first input image, and causes the second image to be formed on the second sheet based on the second input image.

In a case of utilizing this input image example, the final output product is the double-page spread product, on which a first output image B1 (the letter “A”) based on the first input image is placed on the first sheet, and a second output image B2 (the letter “B”) based on the second input image is placed on the second sheet. The first and second output images B1 and B2 are collectively referred to as output images B1/B2. The first output image B1 is an example of the first image, and the second output image B2 is an example of the second image. Apart from the differences in the input images, each item in FIG. 12 corresponds to FIG. 6 of the first embodiment. Hereinafter, the specific production methods for the double-page spread product in Comparative Example 2, Example 3, and Example 4 will be described.

### Comparative Example 2

As illustrated in an upper section of FIG. 12, in Comparative Example 2, similar to the conventional duplex printing, while conveying the first and second sheets, the first output image B1 is formed on the front side of the first sheet, and the second output image B2 is formed on the back side of the second sheet. Then, the heat-and-pressure bonding process is performed in the sheet processing apparatus 106 such that the front side of the first sheet and the back side of the second sheet form the double-page spread.

Conveyance sequences of the first and second sheets in Comparative Example 2 are the same as Comparative Example 1 except that the output images B1/B2 is formed instead of the segmented images A1/A2; therefore, the description will be omitted. That is, in FIG. 7, by substituting “first segmented image A1” with “first output image B1” and “second segmented image A2” with “second output image B2”, a flowchart that represents a procedure for producing the double-page spread product in Comparative Example 2 is formed.

In Comparative Example 2, while the first output image B1 is transferred onto the first sheet before the first sheet has passed through the fixing unit 118 for the first time (STEP S1a), the second output image is transferred (STEP S2d) onto the second sheet which has already once passed through the fixing unit 118 (STEP S2b). Therefore, while the first output image B1 shrinks in conjunction with shrinkage of the first sheet when the first sheet passes through the fixing unit 118 for the first time, the second output images undergoes less shrinkage. As a result, as illustrated in the “printing result” and “final output product” of FIG. 12, a difference in the image sizes occurs between the left and right sides of the double-page spread.

### Example 3

As illustrated in a central section of FIG. 12, in Example 3, both the first and second output images B1 and B2 are transferred onto the sheets which are in a state of not having passed through the fixing unit 118 even once.

The conveyance sequences of the first and second sheets in Example 3 are the same as Example 1 except that the output images B1/B2 is formed instead of the segmented images A1/A2; therefore, the description will be omitted. That is, in FIG. 8, by substituting “first segmented image A1” with “first output image B1” and “second segmented image A2” with “second output image B2”, a flowchart that represents a procedure for producing the double-page spread product in Example 3 is formed.

In Example 3, the first output image B1 is transferred onto the first sheet before the first sheet has passed through the fixing unit 118 for the first time (STEP S3b), and the second output image B2 is transferred onto the second sheet before the second sheet has passed through the fixing unit 118 for the first time (STEP S4b). Therefore, the first output image B1 shrinks in conjunction with shrinkage of the first sheet when the first sheet passes through the fixing unit 118 for the first time, and the second output image B2 shrinks in conjunction with shrinkage of the second sheet when the second sheet passes through the fixing unit 118 for the first time. As a result, as illustrated in the “printing result” and “final output product” of the central section of FIG. 12, both the output images B1/B2 slightly shrinks compared to the time of the transfer, so that the occurrence of the difference in the image sizes between the left and right sides of the double-page spread can be avoided.

In other words, in Example 3, the control unit executes the following operations when producing the output product in which the first and second images are formed on the double-page spread constituted by the first and second sheets. Before the first sheet passes through the fixing unit for the first time, the control unit causes transfer of the first image onto the first sheet by the transfer member, and causes fixing of the first image on the first sheet by the fixing unit. In addition, before the second sheet passes through the fixing unit for the first time, the control unit causes transfer of the second image onto the second sheet by the transfer member, and causes fixing of the second image on the second sheet by the fixing unit. Further, the control unit causes conveyance of the first and second sheets to the binding unit such that the first and second images face each other, and causes binding of the first and second sheets by the binding unit.

According to the present disclosure, an image forming apparatus and a method for producing a product, which are capable of suppressing a difference in image size between images in a product, can be provided. Further, an image forming apparatus capable of suppressing a difference in image size on a double-page spread can be provided.

### Example 4

As illustrated in a lower section of FIG. 12, in Example 4, both the first and second output images B1 and B2 are transferred onto the sheets which have passed through the fixing unit 118 at least once.

The conveyance sequences of the first and second sheets in Example 4 are the same as Example 2 except that the output images B1/B2 is formed instead of the segmented images A1/A2; therefore, the description will be omitted. That is, in FIG. 9, by substituting “first segmented image A1” with “first output image B1” and “second segmented image A2” with “second output image B2”, a flowchart that represents a procedure for the double-page spread production job in Example 4 is formed.

In Example 4, the first output image B1 is transferred onto the first sheet which has passed through the fixing unit 118 at least once (STEP S5b), and the second output image is transferred onto the second sheet which has passed through the fixing unit 118 at least once (STEP S6b). That is, the first output image is transferred onto the sheet which has already shrunken, and the second output image is transferred onto the sheet which has already shrunken. Therefore, even when the first and second sheets pass through the fixing unit 118 for the second time for fixing, the first and second sheets undergo less shrinkage, and the output images B1/B2 is less likely to become smaller compared to the time of the transfer. As a result, as illustrated in the “printing result” and “final output product” of the lower section of FIG. 12, both the output images B1/B2 is output substantially at the same size as at the time of the transfer, so that the occurrence of the difference in the image sizes between the left and right sides of the double-page spread can be avoided.

In other words, in Example 4, the control unit executes the following operations when producing the output product in which the first and second images are formed on the double-page spread constituted by the first and second sheets. The control unit causes transfer of the first image onto the first sheet by the transfer member after the first sheet has passed through the fixing unit at least once, and causes fixing of the first image on the first sheet by the fixing unit. In addition, the control unit causes transfer of the second image onto the second sheet by the transfer member after the second sheet has passed through the fixing unit at least once, and causes fixing of the first image on the second sheet by the fixing unit. Further, the control unit causes conveyance of the first and second sheets to the binding unit such that the first and second images face each other, and causes binding of the first and second sheets by the binding unit.

With this configuration, an image forming apparatus capable of suppressing a difference in image size on a double-page spread can be provided.

### Modified Examples

In Example 3 and Example 4, in the case of producing the double-page spread product, by performing additional reverse conveyance on the first or second sheet after the transfer of the image, the first and second sheets are conveyed to the heat-and-pressure bonding unit 167 such that the sheet surfaces constituting the double-page spread face each other. It is not limited to this, and it is acceptable to control the conveyance route of the first and second sheets to the heat-and-pressure bonding unit 167 (binding unit) such that the sheet surfaces constituting the double-page spread are oriented to face each other utilizing the shortcut path 131 and the switching guide 132 described in the second embodiment.

### Other Modified Examples

While, in this embodiment, a tandem type color printer configuration with four process cartridges is exemplified, the number of toner types may be equal to or more than five or equal to or less than three. In addition, instead of using the configuration where at least one of the plurality of colors of toners is used both as the toner (printing toner) for recording the image on the sheet and as the adhesive toner, it is acceptable to use a toner specifically dedicated to bonding. In this case, in the process cartridge using the dedicated adhesive toner, only the adhesive toner image 39 (FIG. 5) is formed.

In addition, the printer main body 101 may be a monochrome image forming apparatus equipped with only one process cartridge 195 that uses the black toner Tk as both the printing toner and the adhesive toner.

In addition, the heat-and-pressure bonding unit 167 is an example of the binding unit for binding a plurality of sheets, and a stapler that uses staples or a staple-free stapler, which performs binding without staples, can be used as the binding unit. The staple-free binding process involves integrating a sheet bundle by folding back a cut-out portion of the sheet or by clamping sheets with a tooth pattern to entangle fibers and unite the sheet bundle.

In addition, while, in the embodiments described above, the image forming apparatus 100 applies the adhesive toner to the sheet and the heat-and-pressure bonding unit 167 bonds the sheet, it is acceptable to use the sheet that has already been coated with the adhesive toner as the recording material, and perform only bonding using the heat-and-pressure bonding unit 167.

In addition, in the embodiments described above, the number of times each of the two sheets constituting the double-page spread passes through the fixing unit 118 before the image is transferred is equalized. Instead of this, it is acceptable to reduce the difference in the image sizes on the double-page spread by altering the magnification of the images formed by the image forming unit 101B between two image (first and second images) formed on the double-page spread, taking into account the shrinkage of the sheets. The magnification of the image is a setting value that represents a ratio by which the image is enlarged or reduced on the actual sheet with respect to the size of the input image. For example, in a case of conveying the first and second sheets using the conveyance sequence of Comparative Example 1 (FIG. 7), the magnification of the second segmented image A2 is set slightly smaller than the magnification of the first segmented image A1. In this case, while the size of the second segmented image A2 immediately after the transfer is smaller than that of the first segmented image A1 immediately after the transfer, the first segmented image A1 shrinks in conjunction with shrinkage of the first sheet when the first sheet passes through the fixing unit 118 for the first time. Thereby, the size difference between the first and second segmented images A1 and A2 in the final output product can be reduced. This modified example can also be applied to the third embodiment in which two input images are input. In that case, by setting different magnification ratios for the magnification of the first output image with respect to the first input image and the magnification of the second output image with respect to the second input image, it is possible to achieve the same advantages as the example described above.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-088166, filed May 30, 2024, which is hereby incorporated by reference herein in its entirety.

What is claimed is:

1. An image forming apparatus comprising:
a transfer member configured to transfer an image onto a sheet;
a fixing unit configured to fix the image on the sheet by heating the sheet;
a binding unit configured to bind a plurality of sheets; and
a control unit configured to perform a job for producing a product formed by a first surface of a first sheet and a second surface of a second sheet,
wherein, in the job, the control unit is configured to cause:
(i) transfer of a first image onto the first surface of the first sheet by the transfer member before the first sheet passes through the fixing unit for a first time,
(ii) fixing of the first image on the first sheet by the fixing unit,
(iii) transfer of a second image onto the second surface of the second sheet by the transfer member before the second sheet passes through the fixing unit for a first time,
(iv) fixing of the second image on the second sheet by the fixing unit, and
(v) binding of the first sheet and the second sheet by the binding unit such that the first surface and the second surface face each other.

2. The image forming apparatus according to claim 1,
wherein, in a case of forming images on two sheets by assigning a single input image onto the two sheets, the control unit is configured to generate first image data and second image data from the single input image and cause the first image to be formed on the first sheet based on the first image data and the second image to be formed on the second sheet based on the second image data.

3. The image forming apparatus according to claim 1,
wherein, in a case of being instructed to form a first input image and a second input image on different sheets, the control unit is configured to cause the first image to be formed on the first sheet based on the first input image and the second image to be formed on the second sheet based on the second input image.

4. The image forming apparatus according to claim 1, further comprising:
a reconveyance unit configured to reverse a sheet that has passed through the fixing unit and convey the reversed sheet toward the transfer member,
wherein the control unit is configured to cause:
(a) the first sheet, on which the first image has been fixed by the fixing unit, to again be passed through the transfer member and the fixing unit using the reconveyance unit and then conveyed to the binding unit, and
(b) the second sheet, on which the second image has been fixed by the fixing unit, to again be conveyed to the binding unit without being passed through the transfer member and the fixing unit using the reconveyance unit, so that the first surface and the second surface face each other in the binding unit.

5. The image forming apparatus according to claim 1, further comprising:
a reconveyance unit configured to reverse a sheet that has passed through the fixing unit and convey the reversed sheet toward the transfer member,
wherein the control unit is configured to cause:
(a) the first sheet, on which the first image has been fixed by the fixing unit, to be again conveyed to the binding unit without being passed through the transfer member and the fixing unit using the reconveyance unit, and
(b) the second sheet, on which the second image has been fixed by the fixing unit, to again be passed through the transfer member and the fixing unit using the reconveyance unit and then conveyed to the binding unit, so that the first surface and the second surface face each other in the binding unit.

6. The image forming apparatus according to claim 1, further comprising:
a first conveyance path and a second conveyance path that branch at a branch portion downstream of the fixing unit in a sheet conveyance direction and merge at a merging portion upstream of the binding unit in the sheet conveyance direction, wherein a sheet conveyed through the first conveyance path is reversed on a way from the branch portion to the merging portion, and wherein a sheet conveyed through the second conveyance path is conveyed without being reversed from the branch portion to the merging portion; and
a switching member configured to switch a conveyance route of a sheet between the first conveyance path and the second conveyance path,
wherein the control unit is configured to control a conveyance route of the first sheet and a conveyance route of the second sheet using the switching member, so that the first surface and the second surface face each other in the binding unit.

7. The image forming apparatus according to claim 1,
wherein the binding unit is configured to bond the first sheet and the second sheet by applying heat and pressure to the first sheet and the second sheet in a state in which an adhesive is applied to at least one of the first sheet and the second sheet.

8. The image forming apparatus according to claim 7, further comprising:
an image forming unit including the transfer member and configured to form the first image and the second image on the first sheet and the second sheet, respectively, using printing toner and to apply an adhesive toner to the at least one of the first sheet and the second sheet.

9. The image forming apparatus according to claim 1,
wherein the product includes a double-page spread,
wherein, in the job, the control unit is configured to cause transfer of a third image onto a surface of the first sheet opposite to the first surface and transfer of a fourth image onto a surface of the second sheet opposite to the second surface, so that the third image and the fourth image are formed on a back side of the double-page spread in the product, and
wherein the control unit is configured to control conveyance of the first sheet and the second sheet such that a number of times the first sheet passes through the fixing unit before the third image is transferred and a number of times the second sheet passes through the fixing unit before the fourth image is transferred become equal.

10. An image forming apparatus comprising:
a transfer member configured to transfer an image onto a sheet;
a fixing unit configured to fix the image on the sheet by heating the sheet;
a binding unit configured to bind a plurality of sheets; and
a control unit configured to execute a job for producing a product formed by a first surface of a first sheet and a second surface of a second sheet,
wherein, in the job, the control unit is configured to cause:
(i) transfer of a first image onto the first surface of the first sheet by the transfer member after the first sheet has passed through the fixing unit at least once,
(ii) fixing of the first image on the first sheet by the fixing unit,
(iii) transfer of a second image onto the second surface of the second sheet by the transfer member after the second sheet has passed through the fixing unit at least once,
(iv) fixing of the second image on the second sheet by the fixing unit, and
(v) binding of the first sheet and the second sheet by the binding unit such that the first surface and the second surface face each other.

11. The image forming apparatus according to claim 10, further comprising:
a feed unit configured to feed a sheet toward the transfer member; and
a reconveyance unit configured to reverse a sheet that has passed through the fixing unit and convey the reversed sheet toward the transfer member,
wherein the control unit is configured to control conveyance of the first sheet and the second sheet using the reconveyance unit such that a number of times the first sheet passes through the fixing unit before the first image is transferred onto the first sheet since the first sheet is fed by the feed unit and a number of times the second sheet passes through the fixing unit before the second image is transferred onto the second sheet since the second sheet is fed by the feed unit become equal.

12. The image forming apparatus according to claim 10, further comprising:
a feed unit configured to feed a sheet toward the transfer member; and
a reconveyance unit configured to reverse a sheet that has passed through the fixing unit and convey the reversed sheet toward the transfer member,
wherein the control unit is configured to cause:
reversing of the first sheet, which has been fed by the feed unit and has passed through the transfer member and the fixing unit for a first time without having an image formed thereon, by the reconveyance unit,
transfer of the first image onto the first surface of the first sheet by the transfer member when the first sheet passes through the transfer member for a second time,
reversing of the second sheet, which has been fed by the feed unit and has passed through the transfer member and the fixing unit for a first time without having an image formed thereon, by the reconveyance unit, and
transfer of the second image onto the second surface of the second sheet by the transfer member when the second sheet passes through the transfer member for a second time.

13. The image forming apparatus according to claim 10,
wherein, in a case of forming images on two sheets by assigning a single input image onto the two sheets, the control unit is configured to generate first image data and second image data from the single input image and cause the first image to be formed on the first sheet based on the first image data and the second image to be formed on the second sheet based on the second image data.

14. The image forming apparatus according to claim 10,
wherein, in a case of being instructed to form a first input image and a second input image on different sheets, the control unit is configured to cause the first image to be formed on the first sheet based on the first input image and the second image to be formed on the second sheet based on the second input image.

15. The image forming apparatus according to claim 10, further comprising:
a reconveyance unit configured to reverse a sheet that has passed through the fixing unit and convey the reversed sheet toward the transfer member,
wherein the control unit is configured to cause:
(a) the first sheet, on which the first image has been fixed by the fixing unit, to again be passed through the transfer member and the fixing unit using the reconveyance unit and then conveyed to the binding unit, and
(b) the second sheet, on which the second image has been fixed by the fixing unit, to again be conveyed to the binding unit without being passed through the transfer member and the fixing unit using the reconveyance unit, so that the first surface and the second surface face each other in the binding unit.

16. The image forming apparatus according to claim 10, further comprising:
a reconveyance unit configured to reverse a sheet that has passed through the fixing unit and convey the reversed sheet toward the transfer member,
wherein the control unit is configured to cause:
(a) the first sheet, on which the first image has been fixed by the fixing unit, to again be conveyed to the binding unit without being passed through the transfer member and the fixing unit using the reconveyance unit, and
(b) the second sheet, on which the second image has been fixed by the fixing unit, to again be passed through the transfer member and the fixing unit using the reconveyance unit and then conveyed to the binding unit, so that the first surface and the second surface face each other in the binding unit.

17. The image forming apparatus according to claim 10, further comprising:
a first conveyance path and a second conveyance path that branch at a branch portion downstream of the fixing unit in a sheet conveyance direction and merge at a merging portion upstream of the binding unit in the sheet conveyance direction, wherein a sheet conveyed through the first conveyance path is reversed on a way from the branch portion to the merging portion, and wherein a sheet conveyed through the second conveyance path is conveyed without being reversed from the branch portion to the merging portion; and
a switching member configured to switch a conveyance route of a sheet between the first conveyance path and the second conveyance path,
wherein the control unit is configured to control a conveyance route of the first sheet and a conveyance route of the second sheet using the switching member, so that the first surface and the second surface face each other in the binding unit.

18. The image forming apparatus according to claim 10,
wherein the binding unit is configured to bond the first sheet and the second sheet by applying heat and pressure to the first sheet and the second sheet in a state in which an adhesive is applied to at least one of the first sheet and the second sheet.

19. The image forming apparatus according to claim 18, further comprising:
an image forming unit including the transfer member and configured to form the first image and the second image on the first sheet and the second sheet, respectively, using printing toner and to apply an adhesive toner to the at least one of the first sheet and the second sheet.

20. The image forming apparatus according to claim 10,
wherein the product includes a double-page spread,
wherein, in the job, the control unit is configured to cause transfer of a third image onto a surface of the first sheet opposite to the first surface and transfer of a fourth image onto a surface of the second sheet opposite to the second surface, so that the third image and the fourth image are formed on a back side of the double-page spread in the product, and
wherein the control unit is configured to control conveyance of the first sheet and the second sheet such that a number of times the first sheet passes through the fixing unit before the third image is transferred and a number of times the second sheet passes through the fixing unit before the fourth image is transferred become equal.

21. A method for producing a product, the method comprising:
(i) transferring a first image onto a first surface of a first sheet before the first sheet passes through a fixing unit for a first time;
(ii) fixing the first image on the first sheet by heating the first sheet at the fixing unit;
(iii) transferring a second image onto a second surface of a second sheet before the second sheet passes through the fixing unit for a first time;
(iv) fixing the second image on the second sheet by heating the second sheet at the fixing unit; and
(v) binding the first sheet and the second sheet such that the first surface and the second surface face each other, so that a product formed by the first surface of the first sheet and the second surface of the second sheet is produced.

22. A method for producing a product, the method comprising:
(i) transferring a first image onto a first surface of a first sheet after the first sheet has passed through a fixing unit at least once;
(ii) fixing the first image on the first sheet by heating the first sheet at the fixing unit;
(iii) transferring a second image onto a second surface of a second sheet after the second sheet has passed through the fixing unit at least once;
(iv) fixing the second image on the second sheet by heating the second sheet at the fixing unit; and
(v) binding the first sheet and the second sheet such that the first surface and the second surface face each other, so that a product formed by the first surface of the first sheet and the second surface of the second sheet is produced.
